(19) United States
(12) Patent Application Publication
(10) Pub. No.: US 2025/0236545 A1
(43) Pub. Date: Jul. 24, 2025

(54) CATALYST-ENHANCED SUBCRITICAL HYDROTHERMAL DESTRUCTION OF PER- AND POLYFLUOROALKYL SUBSTANCES (PFAS)

(71) Applicant: COLORADO SCHOOL OF MINES, Golden, CO (US)

(72) Inventors: Timothy James Strathmann, Golden, CO (US); Shilai Hao, Golden, CO (US); Lauren Estelle Cronmiller, Golden, CO (US); Edgar Muhumuza, Golden, CO (US)

(21) Appl. No.: 18/905,047

(22) Filed: Oct. 2, 2024

Related U.S. Application Data
(60) Provisional application No. 63/587,281, filed on Oct. 2, 2023.

(51) Int. Cl. C02F 1/72; B01J 21/06; B01J 21/18; B01J 23/46; C02F 101/36

(52) U.S. Cl. CPC C02F 1/725; B01J 21/066; B01J 21/18; B01J 23/462; C02F 2101/36

(57) ABSTRACT

As disclosed herein, solid heterogeneous catalysts, meaning catalysts having a different phase than the reacting medium, may be used in combination with hydrothermal treatment conditions to degrade, remove, and/or de-fluorinate PFAS solutions. As described herein, heterogeneous catalysts can be tunable, recyclable, and easy to implement in traditional treatment systems or processes. A heterogeneous catalyst, such as 5% ruthenium on carbon catalyst (Ru/C) or tetragonal zirconium dioxide (t-ZrO₂), can be applied or added during hydrothermal treatment of PFAS-contaminated solutions. In some examples, the combination of the heterogeneous catalyst and hydrothermal treatment may achieve over 99% degradation of PFAS contaminants. Applying or adding the heterogeneous catalyst during hydrothermal treatment of PFAS may also achieve over 20% defluorination of the PFAS. In some examples, a base amendment may further be added or applied to the treatment of the PFAS contaminants to aid in the degradation and/or recovery of the contaminants. For example, a stoichiometric excess of base amendments, such as (NaOH), may lead to nearly complete defluorination within approximately 2 hours of reaction.

### CROSS-REFERENCE TO RELATED APPLICATION

The present application claims the benefit of U.S. Provisional Patent Application No. 63/587,281, filed Oct. 2, 2023, which is hereby incorporated by reference in its entirty.

### FIELD

Compositions, methods, and systems useful in the remediation of PFAS-contaminated media.

### BACKGROUND

The United States Environmental Protection Agency's proposed regulatory limit for per- and polyfluoroalkyl substances (PFAS), including perfluorooctane sulfate (PFOS) and perfluoroalkyl acid (PFOA), stress urgent need for treatment strategies. Many current treatment options for PFAS contaminants are expensive, are challenging for use in treating complex media or solutions, including concentrate streams derived from other treatment processes like ion exchange, membrane filtration, and foam fractionation, and/or are difficult to implement or combine into traditional treatment systems. What is needed are compositions, methods, and systems for treating PFAS contaminants that are cost effective, effective in treating complex media or solutions, and/or combine readily with existing treatment systems.

### BRIEF DESCRIPTION OF THE FIGURES

FIG. 1 shows PFOS extraction from a heterogeneous catalyst Ru/C that was sorbed with PFOS from a foam fractionate solution and a diluted PFOS solution.

FIG. 2 depicts results from PFOS degradation by various heterogeneous catalysts.

FIG. 3 shows a time series removal and defluorination data of heterogeneous catalyst Ru/C.

FIG. 4 shows sulfate concentrations from samples reacted for approximately 5 hours at approximately 350 C. Controls 1-4 are Ru/C and water, Ru/C and PFOS, Ru/C and sodium sulfate, and sodium sulfate respectively.

FIG. 5 shows defluorination of a PFAS substance after a 1 M NaOH HALT experiment with no catalyst and a HALT experiment directly following heterogeneous catalyst Ru/C hydrothermal experiment.

FIG. 6 shows defluorination of PFOS after an approximately 1 hour reaction with 100 mg Ru/C and various base amendments.

FIG. 7 is a schematic overview of the disclosed compositions, methods, and systems for treatment of PFAS contamination.

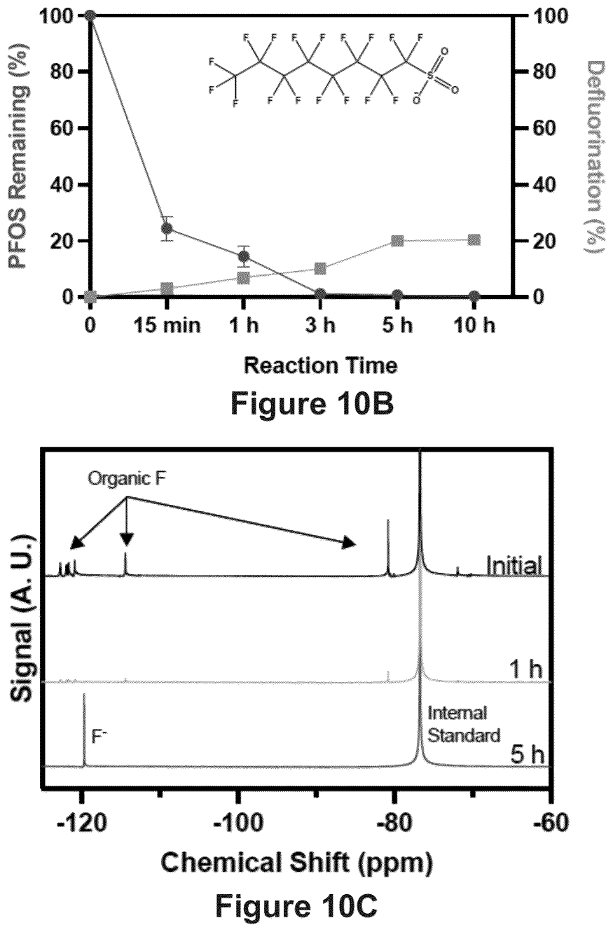

FIG. 8 depicts a orbitrap MS experimental workflow.

FIG. 9 presents the screening of noble metal and metal oxide catalysts for degradation and defluorination of PFBS. Each reaction was performed in duplicate, with 100 mg catalyst and 1 mL of a 60 ppm PFBS solution in deionized water, reacted at 350° C. for 5 h.

FIGS. 10A-C depicts Ru/C facilitated hydrothermal degradation and defluorination of PFBS (FIG. 10A) and PFOS (FIG. 10B and FIG. 10C). Each reaction was performed in triplicate, contained 100 mg Ru/C and 1 mL of a 60 ppm PFBS or a 40 ppm PFOS solution in deionized water, and was reacted at 350° C. 19F-NMR spectra for the initial PFOS stock solution before reaction and extracts collected after 1 h and 5 h reaction.

FIGS. 11A-B depicts degradation and defluorination of PFBS with varying (FIG. 11A) catalyst Ru/C loading to the batch reactor at 350° C. for 15 min and (FIG. 11B) reaction temperatures with standard catalyst loading.

FIG. 12 depicts one embodiment of a product analysis scheme.

FIG. 13 shows LC-HRMS peaks of 1-H-perfluoroalkyl sulfonate intermediate species detected in a 5 h reacted sample extract of PFOS.

FIG. 14 shows semiquantitative estimate of concentrations of 1,1,2,2,3,3,4,4-Octafluorobutane-1-sulphonic acid intermediate (H-PFBS) in Ru/C extract from various reaction times.

FIG. 15 shows removal and defluorination of PFSAs of varying carbon chain length after a 5 h 350° C. reaction with Ru/C. Same conditions as FIGS. 1-2; TFMS (1C), PFEtS (2C), PFBS (4C), and PFOS (8C).

FIG. 16 shows one potential mechanism for hydrothermal PFOS degradation and defluorination over Ru/C catalyst.

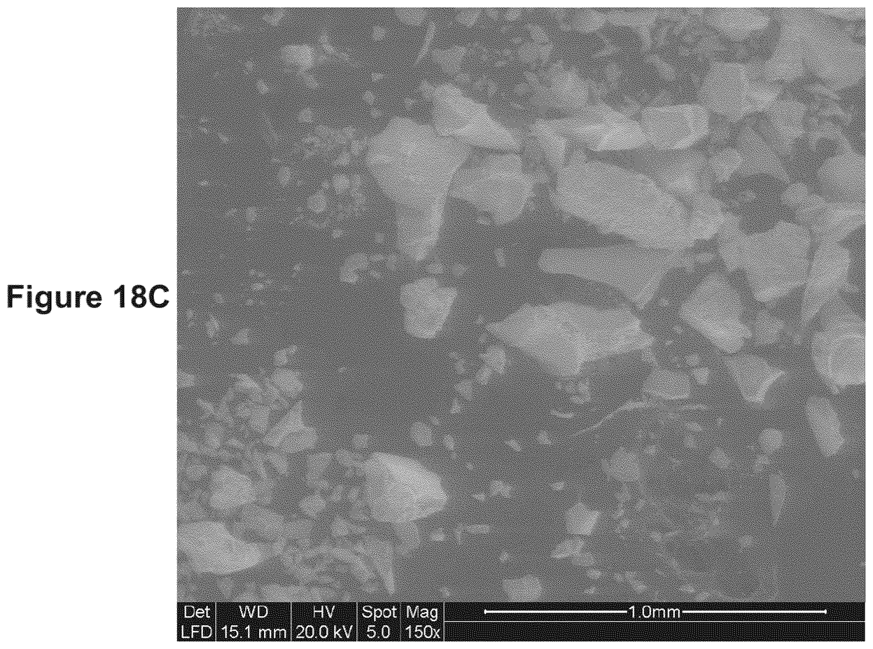

FIGS. 17A-B shows X-ray diffraction patterns (FIG. 17A) and CO₂ temperature programmed desorption data for commercially sourced m-ZrO₂ and in-house synthesized t-ZrO₂ (FIG. 17B).

FIGS. 18A-E show SEM images of t-ZrO₂ (FIG. 18A-D) and EDS spectra of t-ZrO₂ (FIG. 18E).

FIGS. 19A-B shows XRD of spent t-ZrO₂ (FIG. 19A) and m-ZrO₂ (FIG. 19B) after 6 h reaction at 350° C.

FIGS. 20A-E show SEM images (FIG. 20A, FIG. 20B, FIG. 20C, and, FIG. 20D) and, EDS spectra of m-ZrO₂ (FIG. 20E).

FIGS. 21A-B shows degradation (left axis FIG. 21A-B) and defluorination (right axis FIG. 21A-B) of PFBS observed during subcritical hydrothermal reactions. Comparison of m-ZrO2 and t-ZrO2 catalytic activity observed after 3 h of reaction (FIG. 21A). Reaction timecourse for t-ZrO2. Reaction conditions: 350° C., 100 mg catalyst, 1 ml water containing [PFBS]ᵢₙᵢₜ=60 mg/L PFBS (FIG. 21B).

FIGS. 22A-B Defluorination and parent compound degradation of PFSAs with varying chain lengths after 3 h reaction time (FIG. 22A) and PFOA after 3 and 6 h of reaction time (FIG. 22B).

FIG. 23 is a schematic representation of one potential heterogeneous catalytic reaction mechanism for hydrothermal degradation and mineralization of PFBS over t-ZrO₂.

FIG. 24 depicts an example schematic representation of a system for degrading a per- or polyfluoroalkyl substance (PFAS).

FIG. 25 depicts a flowchart illustrating an example method for degrading a per- or polyfluoroalkyl substance (PFAS).

### SUMMARY

Disclosed herein are methods for degrading a per- or polyfluoroalkyl substance (PFAS). In many embodiments, the methods comprise heating a heterogeneous catalyst and/or a solution comprising the PFAS to a temperature greater than about 100° C., combining the heterogeneous catalyst and solution to create a catalyzed composition, and maintaining the catalyzed composition at or near a reaction temperature for a duration sufficient to degrade the PFAS, wherein, in some embodiments the solution may comprise a base amendment, and/or the heterogeneous catalyst may comprise a noble or transition metal on a support, for example a noble or transition metal selected from one or more of nickel, copper, cobalt, manganese, ruthenium, palladium, platinum, rhodium, or iridium. In some embodiments, the support may be selected from carbon, zirconium dioxide or titanium dioxide, and the heterogeneous catalyst comprises one or more of ruthenium on carbon (Ru/C), palladium on carbon (Pd/C), iridium on carbon (Ir/C), rhodium on carbon (Rh/C), platinum on carbon (Pt/C), nickel or nickel copper on zirconium dioxide, or titanium dioxide. In many embodiments, the heterogeneous catalyst comprises zirconium dioxide (ZrO₂), for example monoclinic ZrO₂, tetragonal ZrO₂, or combinations thereof. The reaction temperature may be between about 150° C. and 374° C. In some embodiments, the combining step may include flowing the solution through a bed of heterogeneous catalyst.

Also disclosed are various systems for degrading a per- or polyfluoroalkyl substance (PFAS) in a solution, the system comprising a reactor for containing the solution and a heterogeneous catalyst; a heater for heating one or more of the solution, the heterogeneous catalyst, and the reactor, wherein the reactor is configured to maintain a reaction temperature, an in-flow conduit for transporting the solution to the reactor, and an out-flow conduit for transporting a liquid from the reactor. In many embodiments, the reactor may be configured to contain a bed of heterogeneous catalyst, the in-flow conduit may be in fluid communication with a first side of the reactor and the out-flow conduit may be in fluid communication with a second, opposite side of the reactor, wherein the solution comprises PFAS at a first concentration, and the liquid flowing from the reactor through the out-flow conduit comprises PFAS at a second concentration lower than the first concentration. In many embodiments, the heterogeneous catalyst may comprise a noble or transition metal on a support, for example a noble or transition metal selected from one or more of nickel, copper, cobalt, manganese, ruthenium, palladium, platinum, rhodium, or iridium. In some embodiments, the support may be selected from carbon, zirconium dioxide or titanium dioxide, and the heterogeneous catalyst comprises one or more of ruthenium on carbon (Ru/C), palladium on carbon (Pd/C), iridium on carbon (Ir/C), rhodium on carbon (Rh/C), platinum on carbon (Pt/C), nickel or nickel copper on zirconium dioxide, or titanium dioxide. In many embodiments, the heterogeneous catalyst comprises zirconium dioxide (ZrO2), for example monoclinic ZrO₂, tetragonal ZrO₂, or combinations thereof, and/or the reaction temperature may be between about 150° C. and 374° C. The system may also be configured to collect or handle fuel products produced by the degrading of the PFAS or from one or more other organic compounds in the solution. The disclosed system may be run in continuous or batch mode.

Also disclosed are various per- or polyfluoroalkyl substance (PFAS) degrading heterogeneous catalyst. In some embodiments, the heterogeneous catalyst may comprise a noble or transition metal on a support, for example a noble or transition metal selected from one or more of nickel, copper, cobalt, manganese, ruthenium, palladium, platinum, rhodium, or iridium, and/or a support selected from carbon, zirconium dioxide or titanium dioxide. In many embodiments, the heterogeneous catalyst may comprise one or more of ruthenium on carbon (Ru/C), palladium on carbon (Pd/C), iridium on carbon (Ir/C), rhodium on carbon (Rh/C), platinum on carbon (Pt/C), nickel or nickel copper on zirconium dioxide, or titanium dioxide. In particular embodiments, the heterogeneous catalyst may comprise zirconium dioxide (ZrO₂) for example monoclinic ZrO₂, tetragonal ZrO₂, or combinations thereof, and/or the temperature may be between 150° C. and 374° C.

### DETAILED DESCRIPTION

Per- and polyfluoroalkyl substances (PFAS), such as perfluorooctane sulfate (PFOS) and perfluoroalkyl acid (PFOA), are contaminants that may be harmful to the health of humans and other organisms. PFAS chemicals may be referred to by the public as “forever chemicals” because they break down very slowly. As a result, to remove PFAS chemicals from polluted solutions, such as drinking water, treatment systems and methods are required. However current treatment options may be expensive, and difficult to implement, such as requiring reactions at high temperatures. Some existing treatment options may also face challenges when posed with complex media, such as reacting with other contaminants and producing additional substances requiring further treatment. For example, current systems or methods may use hydrothermal alkaline treatment (HALT) to degrade or remove PFAS substances. This process may require high concentrations of strong base amendments (often greater than 1 mol/L NaOH), this may increase chemical input costs, promote corrosion of reactor materials, and/or generate output solutions containing concentrated bases and/or salts, which require further treatment.

The use of solid heterogeneous catalysts for the treatment of PFAS contaminants, as disclosed herein, may provide a solution. As disclosed herein, solid heterogeneous catalysts may be used in combination with hydrothermal treatment to remove (such as by mineralization), degrade, or de-fluorinate PFAS molecules. Heterogeneous catalysts may refer to catalysts having a different phase than the reacting medium. For example, the heterogeneous catalysts may be in a solid phase and react with a liquid contain PFAS substances. Various amounts of the heterogeneous catalyst may be used. The amount of heterogeneous catalyst used may correspond to a predicated or known concentration of PFAS in a solution. Examples of heterogeneous catalysts may include, without limitation, one or more of noble or transition metals. The noble or transition metals may be immobilized on carbon, zirconium dioxide, or titanium dioxide support materials. In some examples, combinations or alloys of the noble or transition metals may be used. Noble metals may include one or more of ruthenium, palladium, platinum, rhodium, or iridium. Transition metals may include one or more of nickel, copper, cobalt, iron, manganese, zinc, titanium, or zirconium. For example, the heterogeneous catalyst may be, without limitation, one or more of ruthenium, palladium, iridium, rhodium, or platinum on carbon (i.e. Ru/C, Pd/C, Ir/C, Rh/C, and Pt/C), the same metals immobilized on other hydrothermal support materials, including zirconium dioxide, titanium dioxide, or cerium dioxide. They may also be transition metals immobilized on the same support materials, including nickel copper on zirconium dioxide, nickel on zirconium dioxide, or zirconium dioxide. In some examples, a range of heterogeneous catalyst concentrations may be use. In some embodiments, between 1 and 10% active metal on carbon, zirconium dioxide, or titanium dioxide support may be used, for example, 5% ruthenium on activated carbon. In many embodiments, the ZrO₂ catalyst may be monoclinic (m), or tetragonal (t), or mixtures thereof.

In some examples, at least 20-40%, nickel and copper on zirconium dioxide may be used, for example, 30% nickel and copper on zirconium dioxide.

The heterogeneous catalysts can be tunable, recyclable, and easy to implement in traditional treatment systems. In addition, some heterogeneous catalysts may act to convert degraded PFAS substances, such as organic co-constituents (e.g., dissolved natural organic matter that may be present in a reaction solution) into gaseous fuel products (e.g., hydrogen, methane), which may be of economic value.

Disclosed herein are technologies for treating various media, for example liquid solutions, contaminated with per- and polyfluoroalkyl substances (PFAS). In some cases, the disclosed compositions, methods, or systems may achieve removal, destruction, or defluorination of the contaminants. This may be accomplished by applying subcritical hydrothermal reaction conditions, for example condensed phase water at temperatures ranging from 150-374° C., together with heterogeneous catalysts to a PFAS containing solution. In some examples, the heterogeneous catalysts may be one or more separate heterogeneous catalysts. Application of heterogeneous catalysts may reduce or eliminate the need for additions of strong base amendments, as may be needed or required in other technologies such as existing hydrothermal alkaline treatment processes. Some catalysts, such as ruthenium and nickel-based catalysts, may also convert organic co-constituents in the PFAS-contaminated solutions to gaseous fuel products of economic value.

The disclosed heterogeneous catalysts may be used in place of or in addition to base amendments. For example, alkali solution amendments or other base amendments may be included with the heterogeneous catalysts, or the heterogeneous catalyst and base amendments may be added separately or sequentially to the contaminated media. In some embodiments, the disclosed heterogeneous catalysts may eliminate, or significantly reduce, the concentrations of a required base.

The disclosed hydrothermal reaction may aid in gasifying one or more organic constituents that may be present in the reaction solution. The gasification of the organic constituents may produce fuel products (e.g., hydrogen or methane).

As described herein, various heterogeneous catalysts may be used with the disclosed compositions, methods, and systems. In some examples, the heterogeneous catalyst may comprise ruthenium, for example ruthenium on carbon. In one example, a 5 wt % ruthenium on carbon heterogeneous catalyst, Ru/C, (e.g., 5 wt % Ru and 95% carbon) can be added to the hydrothermal reaction for treatment of PFAS-contaminated media.

The combination of a heterogeneous catalyst and hydrothermal treatment may achieve complete or nearly complete destruction of the PFAS contaminant. In some embodiments, the range of PFAS destruction may be at least about 50% to greater than 99%, for example greater than about 45%, 50%, 55%, 60%, 65%, 70%, 75%, 80%, 85%, 90%, 95%, 96%, 97%, 98%, or 99%, and less than about 100%, 99%, 98%, 97%, 96%, 95%, 94%, 93%, 92%, 91%, 90%, 85%, 80%, 75%, 70%, 65%, 60%, 55%, or 50% destruction of the PFAS.

Depending upon the conditions of the treated composition, the concentrations or PFAS and/or catalysts and other compounds, and the temperature of the degradation reaction, destruction of PFAS may be achieved between approximately 1 to 5 hours of reaction. For example greater than about 30 min, 35 min, 40 min, 45 min, 50 min, 55 min, 60 min, 65 min, 70 min, 75 min, 80 min, 85 min, 1.5 h, 2 h, 2.5 h, 3 h, 3.5 h, 4 h, 4.5 h, 5 h, 5.5 h, or longer, and less than about 24 h, 18 h, 12 h, 11 h, 10 h, 9 h, 8 h, 7 h, 6 h, 5.5 h, 5 h, 4.5 h, 4 h, 3.5 h, 3 h, 2.5 h, 2 h, 1.5 h, or 1 h, 55 min, 50 min, 45 min, 40 min, 35 min or 30 min. In one example, complete or nearly complete destruction of PFAS may be observed at about 3 hours of reaction.

The combination of a heterogeneous catalyst and hydrothermal treatment may achieve defluorination of the PFAS contaminant. In some embodiments, the amount of defluorination may range from greater than approximately 10% to approximately 100%, for example, greater than or equal to about 5%, 10%, 15%, 20%, 25%, 30%, 35%, 40%, 45%, 50%, 55%, 60%, 65%, 70%, 75%, 80%, 85%, 90%, 95%, 96%, 97%, 98%, or 99%, and less than or equal to about 100%, 99%, 98%, 97%, 96%, 95%, 94%, 93%, 92%, 91%, 90%, 85%, 80%, 75%, 70%, 65%, 60%, 55%, 50%, 45%, 40%, 35%, 30%, 25%, 20%, or 10%. In some embodiment, the disclosed processes may result in about 20% or about 100% defluorination, or greater, for example for example, greater than or equal to about 20%, 25%, 30%, 35%, 40%, 45%, 50%, 55%, 60%, 65%, 70%, 75%, 80%, 85%, 90%, 95%, 96%, 97%, 98%, or 99%, and less than or equal to about 100%, 99%, 98%, 97%, 96%, 95%, 94%, 93%, 92%, 91%, 90%, 85%, 80%, 75%, 70%, 65%, 60%, 55%, 50%, 45%, 40%, 35%, 30%, 25%.

Base or alkali amendments may be added to the disclosed reaction. In these examples, the base amendments may assist in degrading or removing PFAS contaminants from solutions. The base amendments may, in some examples, assist in achieving mineralization of fluoride ions released during the degradation of PFAS contaminants. The base or alkali may be selected from, without limitation, one or more of sodium hydroxide, potassium hydroxide, calcium hydroxide, sodium carbonate, or potassium carbonate. Reaction conditions such as time, temperature, or composition/concentration of the heterogeneous catalyst or base amendment may be adjusted or selected for remediation of the contaminated solution. The use of heterogeneous catalysts may allow substantially less or weaker concentrations of base amendment concentrations when compared to existing systems or methods. For example, existing systems may require a strong base amendment to be added to the solution, such as greater than 1 M NaOH. In contrast, in the present system the base amendments may have a concentration of about 0.001 M to 1 M, for example about 0.01 M sodium hydroxide or about between 0.01 to 1 M sodium carbonate. In some examples, a range of including at least between 0.005 and 0.1 M sodium hydroxide may be used. In some examples, a range of about 0.5 to about 2.0 M sodium carbonate may be used. In some examples, the base amendments may have a pH of approximately equal to or greater than 10.

The disclosed reactions comprising a small stoichiometric excess of base amendment (for example NaOH) may lead to complete (˜100%) or nearly complete (>90% or 95%) defluorination. The base amendment may be added prior to or during the reaction. In one example, the base may be added within approximately 2 hours of reaction.

Without wishing to be restricted by theory, identification of shorter-chain partially defluorinated sulfonic acid structures in some reactions may support a proposed catalytic mechanism initiated by carbon-carbon bond cleavage within the perfluoroalkyl chain in the PFOS structure. The structures may be identified by high-resolution mass spectrometry or similar methods or devices. Reaction of the resulting carbon-centered perfluoroalkyl sulfonate radical with OH— from a base amendment may promote rapid defluorination.

Turning to discussion of example methods, the reactions may be conducted in batch reactors or continuous-flow reactors. For example, the reactions may be conducted in continuous-flow reactors which may support flowing PFAS-contaminated solutions through fixed beds of catalyst solids, or in fluidized beds of catalyst, for one example fluidized catalyst beds suspended in water. In some examples, catalysts may be mixed with PFAS-contaminated water in slurry form in batch operational mode. Contact times and catalyst-to-water ratios can be tailored to achieve desired levels of PFAS destruction and defluorination.

The reactions may be conducted in a heated environment ranging from 150° C. to 374° C., for example greater than about 140° C., 150° C., 160° C., 170° C., 180° C., 190° C., 200° C., 210° C., 220° C., 230° C., 240° C., 250° C., 260° C., 270° C., 280° C., 290° C., 300° C., 310° C., 315° C., 320° C., 325° C., 330° C., 335° C., 340° C., 345° C., 350° C., 355° C., 360° C., 365° C., or 370° C. and less than about 380° C., 375° C., 370° C., 365° C., 360° C., 355° C., 350° C., 345° C., 340° C., 335° C., 330° C., 325° C., 320° C., 315° C., 310° C., 305° C., 300° C., 295° C., 290° C., 2285° C., 280° C., 275° C., 270° C., 265° C., 260° C., 255° C., 250° C., 245° C., 240° C., 235° C., 230° C., 225° C., 220° C., 215° C., 210° C., 205° C., 200° C., 195° C., 190° C., 185° C., 180° C., 175° C., 170° C., 165° C., 160° C., 155° C., 150° C., or 145° C. The heterogeneous catalyst may be added to the reactor. Various amounts of the heterogeneous catalyst may be used. The amount of heterogeneous catalyst used may correspond to a predicated or known concentration of PFAS in a solution. A media, for example a solution, containing PFAS may be added to the reactor.

In some examples, the reactor may require a period of time, after loading the solution and catalyst, to reach a desired temperature. After cooling the heterogeneous catalyst and solution (e.g., the contents of the reactor) may be transferred to a second container. In some examples, the second container may be or associated with a system for separating the contents into a solution portion and a solids portion, for example using a centrifuge.

After separation, the reacted solution may be analyzed or prepared for additional reactions. For example, the reacted solution may undergo a fluoride analysis, a mass spectroscopy, or other analysis to identify and/or detect additional components. In some examples, the reacted solution may be evaporated or dried.

In examples where the reacted solution is dried, it may be heated to remove (e.g., evaporate) excess fluid or solvent and create dried samples. The dried samples may be extracted using various solvents. In some examples, the extraction may involve combining or mixing a heterogeneous catalyst in an extraction solution (such as an ammonium acetate in methanol solution). The extraction solution may be decanted to separate removed or degraded PFAS, such as PFOS, or PFAS byproducts such as fluoride containing compounds. The remaining solution may be tested to verify or determine the removal of the PFAS or fluoride compounds.

In some examples, base amendments may be added to further improve the removal or reduction of PFOS in a solution. In some examples of the catalyst experiments, low concentrations of base amendments may be added to the reaction solution. For example, reactions may be ran as described previously and further may include a weak or less concentrated base amendment such as 0.01 M sodium hydroxide or 1 M sodium carbonate.

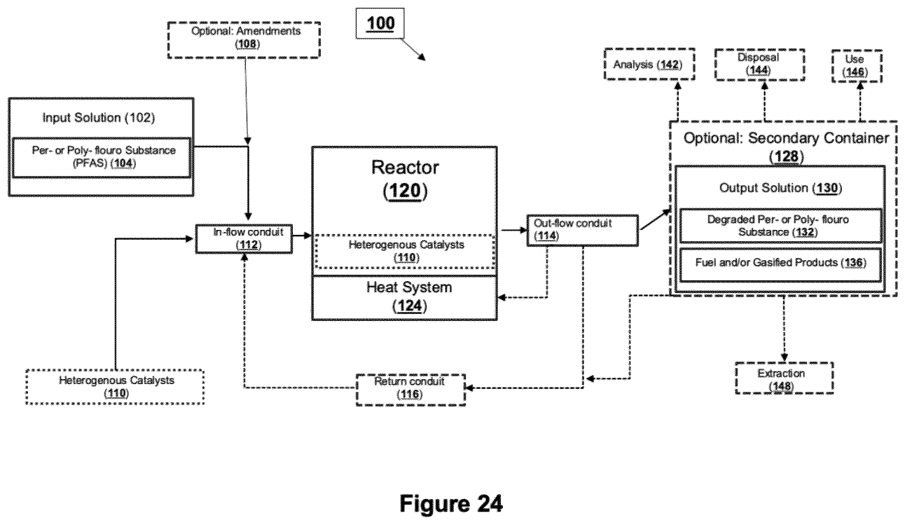

With reference to FIG. 24, an example system 100 for degrading a per- or polyfluoroalkyl substance (PFAS) 104 in a solution 102 is depicted. The system 100 may perform continuous or batch degradation of the PFAS substance 104. The input solution 102 includes the PFAS substance 104 at a first concentration. The input solution 102 may include the PFAS substance 104 prior to operation of the system 100. For example, the input solution 102 may be from an environmental source. The system 100 is configured to receive and degrade PFAS 104 in the input solution 102 through contact with a heterogeneous catalyst 110, such as one or more of the types described herein.

In some examples, the example system 100 may include optional amendments 108 added to the solution, or devices to add optional amendments 108 to the system 100. The optional amendments 108 may be one or more of solvents or reagents, such as base amendments. In some examples, base amendments alone may be added or mixed with the input stream 102 without the need for a solvent. In some embodiments, the optional amendment 108 may include, without limitation, alkalai such as NaOH, KOH, Na₂CO₂, K₂CO₃. In some embodiments, the system 100 may require small amounts of alkali, such as less than or equal to 0.1 mol/L.

The system includes a reactor 120 for containing the solution 102 and one or more heterogeneous catalyst 110 as described herein. The system 100 includes a heat system 124 for heating and/or maintaining a temperature of one or more of the solution 102, the heterogeneous catalyst 110, or the reactor 120. The reactor 120 may include or be operatively connected with the heat system 124. In some examples, the heat system 124 may include two or more heat sources such that one or more of the input solution 102, heterogenous catalyst 110, or reactor 120 may be separately or additionally heated to a reaction temperature. The reactor 120 may maintain the input solution 102 or heterogeneous catalyst at the reaction temperature.

The system 100 may include one or more in-flow conduits 112 for transporting reactants such as the solution, the amendments, etc. to the reactor 120. For example, the inflow conduits 112 may transport at least the input solution 102 to the reactor 120. The system 100 may include one or more out-flow conduits 114 for transporting an output solution or reacted products 130 from the reactor 120. The inflow conduits 112 or outflow conduits 114 may be different, similar, or the same features. For example, in a batch process, the inflow 112 or outflow conduits 114 may be one or more openings to the reactor 120, and in one example the same opening. In most embodiments, the system is run in continuous mode rather than batch morde. In continuous mode examples, the inflow 112 or outflow conduits 114 may input or remove, respectively, solutions continuously or periodically, such as in a continuous flow system. In some examples, the in-flow conduit 112 may be in fluid communication with a first side of the reactor 120 to deliver a PFAS containing Input Solution to the reactor. The outflow conduit 114 may be in fluid communication with a second side of the reactor 120 to aid in removing treated solution from the reactor. The second side may be opposite, spaced from, or adjacent the first side. In some examples, the heat system 124 may be operatively connected with the out-flow conduit 114. The heat system 124 may recover heat energy from the output solution 130 to reduce energy or heat generation requirements at the reactor 120.

The heterogeneous catalyst 110 may be included in the reactor 120, combined with the input solution 102, or added to the reactor 120 with the input solution 120, such as by the inflow conduits 112. In one example, reactor 120 includes a bed of the heterogeneous catalyst 110. If a bed configuration is used, the PFAS-contaminated liquid may flow into and through the bed while the catalysts 110 stay in the fixed bed. In some examples, the reactor or outflow conduits 114 may include one or more devices or perform one or more processes to separate the treated output solution 130 from the catalysts 110, extract heat from the output solution, or collect one or more fuel products from the reactor. For example, a membrane may permit passage of liquids and retain or capture solids in the reactor.

Prior to operation of the system 100, the input solution 102 includes PFAS 104 at a first concentration. An output solution 130 is produced and removed from the reactor, such as by the processes described herein. For examples, output solution 130 may be a liquid flowing from the reactor 120 through the out-flow conduit 114. The output solution 130 PFAS is at a second concentration lower than the first concentration defining a degraded per- or poly-fluoro compound 132. The output solution 130 may additionally include spent heterogenous catalyst 134, or byproducts of an interaction between the heterogeneous catalyst and the 110 and the PFAS 104. In some examples, additional byproducts such as fuel or gasified products 136 may additionally be included in the output solution 130 or otherwise released from the reactor 120.

The system 100 may optionally include a secondary container 128 to hold, mix, or separate the output solution 130. For example, a secondary container 128 may be or associated with a system for separating the output content 128 into a solution portion and a solids portion, for example a centrifuge.

In some examples, the system 100 may optionally include one or more return conduits 116. The return conduits 116 may transport one or more components of the output solution 130 to return to the reactor 120, such as from the out-flow conduit 114 or the secondary container 128. The return conduits 116 may enable additional reaction or degradation cycles. For example, the return conduits 116 may recycle the heterogeneous catalyst 110, the optional amendments 108, or further reduce concentrations of the degraded PFAS substance 132 in the output solution 130.

In some embodiments the input solution 102 may be treated or mixed with additional substances prior to combining with the catalyst 110. For example, the PFAS substance 104 may be initially degraded or the input solution 102 may include additional contaminants separate from or similar to the PFAS substance 104. The system 100 may include potential feed stream pretreatment to remove the additional contaminants. In such embodiments, the system 100 may include systems, containers, or flow paths for removing or reacting one or more of the contaminants, for example catalyst poisons or foulants, present in the input solution 102, or adding the optional amendments 108.

The system 100 may include or be operatively connected with processes for periodic cleaning of the system 100, or re-activation of catalysts in the reactor 120. The system 100 may optionally include one or more pathways or systems to analyze 142, dispose 144, use 146, or extract 148 components of the output solution 130. For example, additional conduits may flow from or provide access to the secondary container 128. In such examples, the system 100 may perform post-treatment steps to polish the output solution 130 for residual PFAS, or byproducts like fluoride ions.

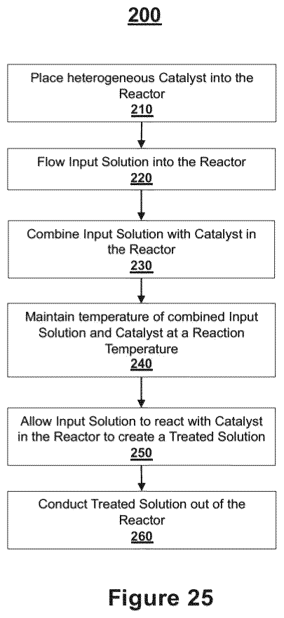

Turning to FIG. 25, an example method 200 for degrading a per- or poly-fluoroalkyl substance (PFAS). The PFAS may be degraded by a heterogeneous catalyst of one or more the types described herein. The method 200 may optionally include step 210 including placing the heterogeneous catalyst into a reactor. The catalyst may be placed in the reactor prior to operation of the system, continuously added during operation, or the like. In one example, the catalyst may be a packed bed configuration placed with in the reactor.

The example method 200 may include step 220, including flowing an input solution into the reactor. The input solution includes a first concentration of the PFAS substance. The input solution may be flowed to the reactor without additional amendments such as a solvent, base amendments, or reagents. In other examples, the additional amendments may be added to the input solution or to the reactor with the input solution.

The example method 200 may include step 230, including combining the input solution with the heterogeneous catalyst in the reactor. For example, the heterogenous catalyst may be mixed with the input solution including the PFAS substance. In some examples, the input solution is flowed or directed over or through the heterogenous catalyst within the reactor.

The example method 200 may include step 240, including maintaining a temperature of the combined input solution and the heterogeneous catalyst at a reaction temperature, such as at the ranges or temperatures described herein. For example, one or both of the input solution and heterogeneous catalyst may be heated before, during, or after combination. In some examples, the reactor includes a heat source or system to increase and maintain the reaction temperature.

The example method 200 includes step 250, including allowing the input solution to react with the heterogeneous catalyst to create a treated solution. The heterogeneous catalyst may facilitate the degradation of the PFAS in the input solution. The heterogenous catalyst and the reaction temperature may result in the partial or complete breakdown of the PFAS within the input solution resulting in the treated solution. The reaction temperature may be maintained for a predetermined duration of time, or until the concentration of PFAS is reduced. After a duration of time, the catalyzed composition may degrade the PFAS to produce extractable PFAS byproducts, fuel products, or various other compounds.

The example method 200 may include step 260 including conducting the treated solution out of the reactor. In some examples, the treated solution may flow directly from the reactor to a secondary container or flow path. In some examples, the treated solution may be removed from the reactor in a discrete volume. Step 260 may include separating the contents of the catalyzed composition into a solution portion and a solids portion. For example, the various products of the methods may be in at least two or more states of solid, liquids, or gases. The treated solution may undergo further operation to remove components of the treated solution, such as resulting products. The resulting products may be extracted for use, such as generated fuel products. The resulting products may be additionally treated to remove byproducts such as Fluoride ions, or waste.

### EXAMPLES

The following examples and experiments are not intended to be limiting. Moreover, the various mechanisms disclosed and discussed below are not intended to limit the scope of the disclosure, rather they are simply illustrative or hypothetical mechanisms proposed by Applicant. By presenting and discussing the various mechanisms, Applicant is expressly not limited by theory.

### Example 1

### Materials and Methods

In general, reactions were conducted in stainless-steel tube batch reactors (1.27 cm outer diameter×10 cm length, 0.12 cm wall thickness, and a total volume of 5.3 mL) using known procedures. Briefly, experimental reactions were conducted in a heated fluidized sand bath set to the subcritical temperature of 350° C., with a catalyst loading of 100 mg and 1 ml of a 40 mg/L PFOS solution loaded into the reactor. Previous studies indicated that the reactor takes <5 min to reach the desired temperature. Thus, reactors were held at 350° C. for the allotted time in addition to 5 min of heat up time. Reactors were then cooled to room temperature using a fan and the contents were poured into a 15 mL polypropylene centrifuge tube and residual was rinsed using 5 ml Milli-Q water into the same tube. The resulting solution was centrifuged at 3000 rpm for 10 min and 2 mL of the aqueous phase was removed for fluoride analysis, and 2 mL was removed for LCMS analysis. The remaining solution was evaporated under N₂ in a 30° C. water bath and heated in a 50° C. oven to dryness overnight. The dried sample was then extracted using 13 mL of a 100 mM ammonium acetate in methanol solution 3 times. The extraction involved vortexing the catalyst in the extraction solution, sonicating for 20 min, and then centrifuging at 3500 rpm for 10 min prior to decanting. Aqueous solutions removed for fluoride analysis were diluted using Milli-Q water and were pH adjusted to 5-5.5 using 10% TISAB. Fluoride concentrations were measured with an ion-selective electrode (ISE) probe. Samples were filtered through a 0.45 um PTFE filter and analyzed using Ion chromatography for sulfate analysis.

When conducting catalyst experiments with low concentration of base amendments, reactions were ran as described previously but with 0.01 M sodium hydroxide or 1 M sodium carbonate and reactions were run for 2 h. Ru-free control reactions were performed using an activated carbon material with no loaded Ru metal. When conducting hydrothermal alkaline treatment (HALT) experiments on spent catalysts, extracted spent catalysts were loaded to the reactors as described previously with the addition of 100 μl of a 10 M NaOH solution. These experiments were run for 1 hour. When conducting sequential HALT, a reaction with Ru/C was run for 5 h, the reactor was opened, and 100 μl of a 10 M NaOH solution was added, the reactor was re-sealed and ran at 350° C. for another 5 h.

PFOS and its intermediates were quantified in post-treatment aqueous samples and catalyst extracts using an LC-Orbitrap-MS (Thermo Fisher Scientific) together with targeted and non-targeted analysis workflows to quantify PFOS and identify any F⁻ containing intermediates from the hydrothermal reaction of PFOS. The details of targeted and non-targeted PFAS analysis workflows can be found elsewhere.

### Results

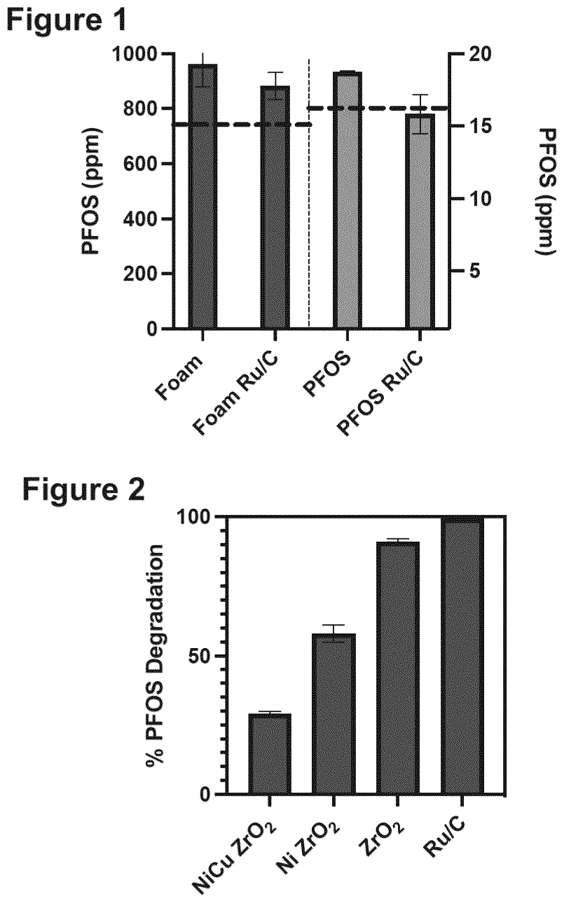

Activated carbon is a known adsorbent for PFAS. Therefore, a method for extracting PFOS from Ru/C before and after reaction at hydrothermal conditions was investigated. FIG. 1 shows that the extraction procedure described in the methods is sufficient for recovering unreacted adsorbed PFOS when using either a diluted PFOS solution or a more complex mixture of PFAS detected in a foam fractionation-derived concentrate solution described previously.

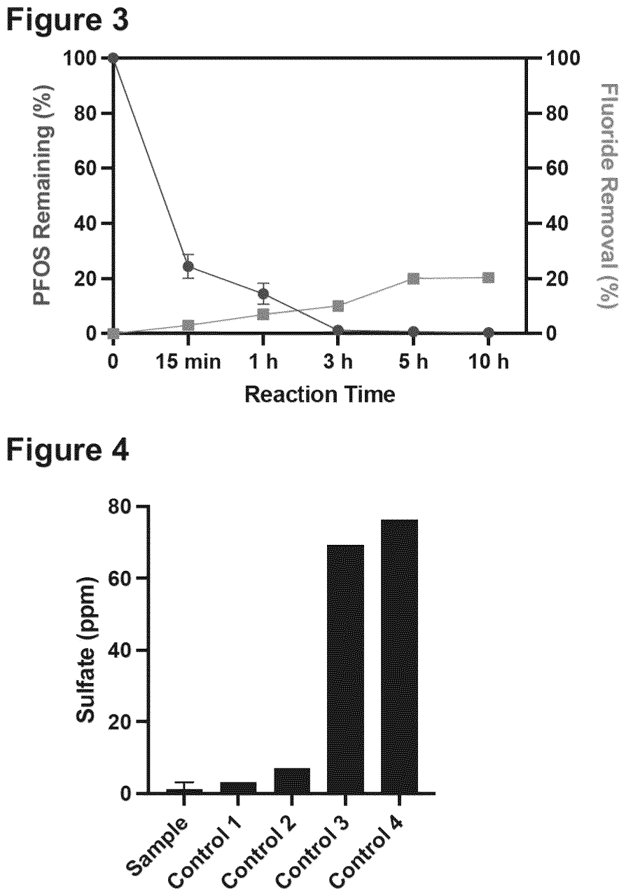

Screening of in-house synthesized ZrO₂ based catalyst was conducted and compared against a commercial Ru/C catalyst for PFOS degradation. Experiments were conducted for 5 h with other conditions as described above. Ru/C spent catalysts were extracted using the procedure validated above. However, tests were conducted to analyze PFOS adsorption to the ZrO₂ surface and found that when ZrO₂ was exposed to a 40 ppm PFOS solution overnight no adsorption was observed. Therefore, extractions were not performed on the catalyst with ZrO₂ based supports. Results from LCMS/MS data confirmed that the degradation efficacy for PFOS were as follows Ru/C>ZrO₂>Ni/ZrO₂>NiCu/ZrO₂ (FIG. 2). For example, as shown in FIG. 2, each of the heterogeneous catalysts tested may have a range of degradation efficacy for PFAS for the given reaction conditions, such as PFOS. Ruthenium on activated carbon (Ru/C) may degrade a range including at least between 90-99% of PFOS. ZrO₂ may degrade a range including at least between 85%-95% of PFOS. Ni/ZrO₂ may degrade a range including at least between 55%-65% of PFOS. NiCu/ZrO₂ may degrade a range including at least between 20-30% of PFOS. In some examples, longer reaction times or higher catalyst loadings may increase the degradation of PFAS.

Tests were also conducted to verify minimal adsorption of fluoride ions, liberated by the reactions, to the catalysts' surface. Results of these tests confirmed that little or no adsorption to the catalyst surface occurred. Specifically, after the virgin catalyst is agitated and exposed to a 2 mM solution of NaF at room temperature overnight, <1% fluoride is lost to the surface. Thus, fluoride generated in the reactions should be detectable in the aqueous phase.

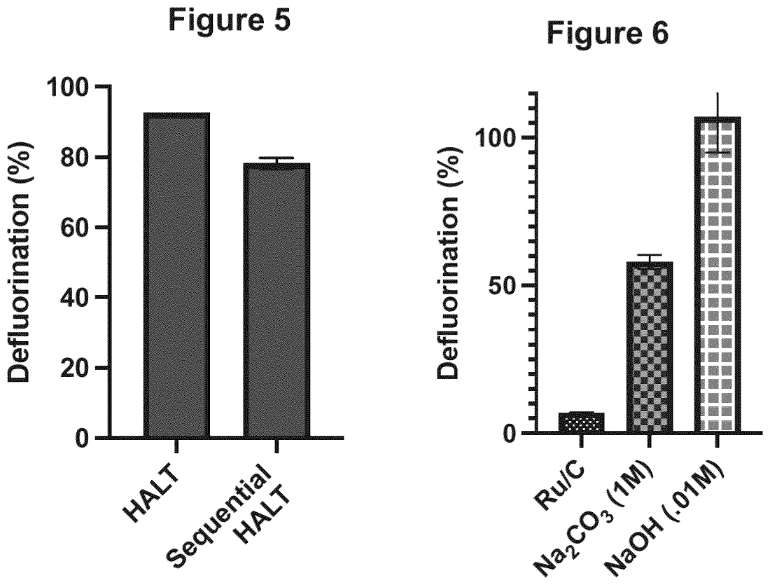

Turning to FIG. 3, the graph illustrates time series removal and defluorination data of Ru/C. The results shown in FIG. 3 may be from under the same conditions as described in FIG. 2. As shown in FIG. 3, degradation of PFAS by a heterogeneous catalyst may occur largely during an initial portion of the reaction, such as up to 1 hour or, in one example, 15 minutes. For example, Ru/C may achieve approximately between 65 and 85% of PFOS removal after the initial portion. In some examples, after approximately 3 hours, greater than 90%, and in one example, 98%, removal may be observed.

In the presence of Ru/C and at 350° C., 75.7% removal of PFOS is achieved from solution after 15 min of hydrothermal treatment. After ˜3 h, >98% removal is observed (FIG. 3). However, a maximum fluoride release of 20% is reached after 5 h of reaction time. Fluoride release and PFOS decay were also validated by ¹⁹F-NMR and IC analysis. Controls described above were performed to confirm minimal fluoride adsorption to the catalyst surface. Thus, we expected the majority of fluoride to be present in the aqueous phase of the post-treatment solution. When comparing against a commercial activated carbon catalyst, <3% defluorination is observed after 5 h of reaction, supporting the conclusion that the immobilized ruthenium is the active catalyst responsible for PFOS transformation.

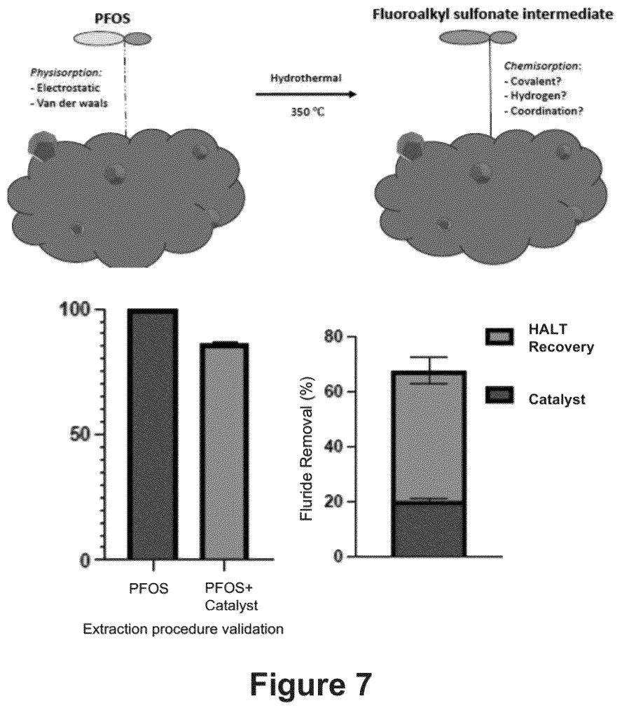

Turning to FIG. 4, illustrates sulfate concentrations of the various samples. For example, the sample may be the average sulfate levels of the experiments of FIG. 2. Control 1 may be Ru/C and water. Control 2 may be Ru/C and PFOS. Control 3 may be Ru/C and sodium sulfate. Control 4 may be sodium sulfate. The results may be from reactions describe previously, such as a reaction for approximately 5 hours at 350 C. Ion chromatography data analysis of reaction solutions after 5 h showed sulfate concentrations consistent with ˜3% of the S in the PFOS added to solution (FIG. 4). However, controls 1 and 2 indicate that the virgin catalyst and unreacted PFOS stock solution respectively contribute more sulfate to solution than is recovered in the post-reaction solution, indicating that no significant sulfate is liberated during the reactions depicted in FIG. 3. Further, controls 3 and 4 confirm that no significant portion of sulfate is adsorbed to the catalyst.

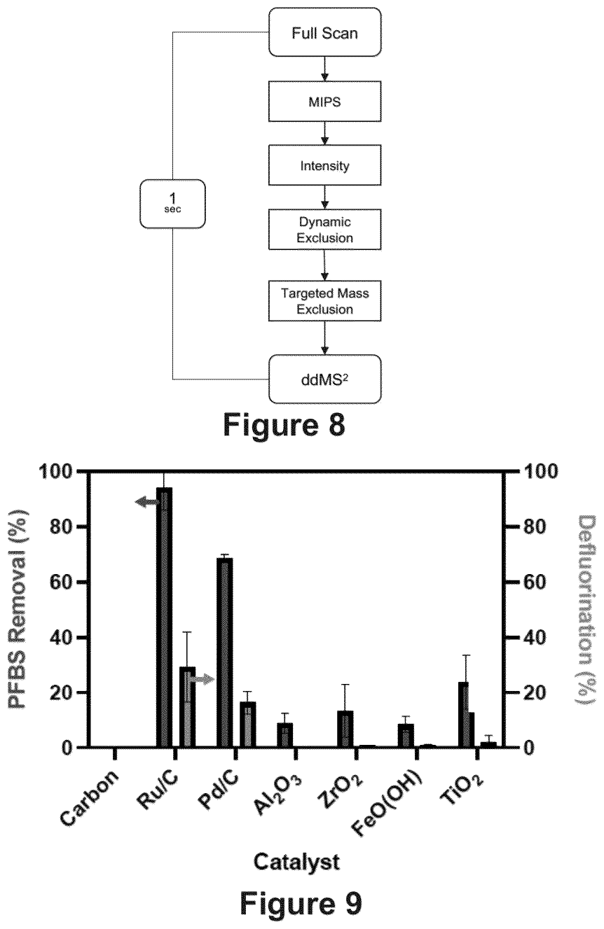

Turning to FIG. 5, illustrating defluorination or percentages of fluoride recovered from a sequential HALT reaction compared against a reaction of conventional HALT reactions with no catalyst. For example, FIG. 5 may illustrate defluorination (e.g., percentage of fluoride removed) after a strong base (e.g. greater than or equal to 1 M NaOH) HALT experiment with no catalyst and a HALT experiment directly following a 5 hour Ru/C hydrothermal experiment. Sequential HALT reactions were also conducted to verify that a significant portion of the fluorinated intermediates were not released as volatiles. These results are shown in FIG. 5, where the fluoride recovered from the sequential HALT is compared against a reaction of conventional HALT with no catalyst. The significantly enhanced defluorination from 20% to 78% suggests majority of the fluorinated intermediates are not volatilized.

Additionally, five hour spent Ru/C catalysts which were extracted and analyzed for PFOS destruction were then reacted for 2 h at the same conditions with 1 M NaOH added (i.e., standard HALT conditions). This HALT treatment was able to recover an additional 47% of the fluoride. This, in addition to the 20% fluoride removal achieved by the catalyst reaction alone, results in a 67% fluorine mass balance closure. We expect that some of the catalyst may be lost during reactor rinsing steps and extraction, which may account for some of this loss. We also conducted spent catalyst rinsing with sodium nitrate solution, which has been shown to be successful for fluoride removal from activated carbon. Through three washes we were able to recover an additional 3% total fluoride recovery from a spent catalyst reacted for 10 h.

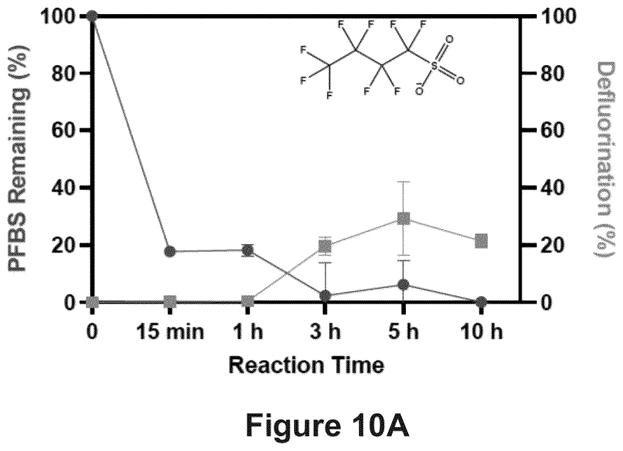

In some examples, base amendments may be added to the heterogeneous hydrothermal reaction, or a HALT reaction may be run after the hydrothermal reaction. The base amendments for a HALT reaction after a hydrothermal reaction including a heterogeneous catalyst may be weaker and/or less concentrated. Turning to FIG. 6, the bar graph illustrates exemplary defluorination of a PFAS, such as PFOS, after approximately a 1 h reaction with 100 mg Ru/C and various base amendments. Base amendment experiments were able to increase defluorination of PFOS after 1 h to 58% and 107% of the estimated fluorine content of the added PFOS for sodium carbonate and sodium hydroxide respectively (FIG. 6). It should be noted that, in surprising contrast to the present disclosure, Wu and coworkers previously reported that 0.01 M NaOH, alone, was able to de-fluorinate <5% PFOS after 90 min at a temperature of 350° C. Thus, the additional defluorination is not attributable to hydrothermal solution-phase reactions with OH⁻.

In some examples, the heterogeneous catalyst may assist in producing fuel as a byproduct of the degradation of the PFAS substances. experiments were conducted using Ru/C catalyst for hydrothermal decomposition of PFAS and simultaneous gasification of dissolved organic carbon (DOC) in industrially sourced, concentrated foam fractionate with elevated PFAS concentrations (1,940 mg/L) and DOC (9,100 mg/L C). Residual PFASs and DOC were extracted from the Ru/C and analyzed with LCMS/MS and a TOC analyzer, respectively. Disappearance of TOC is consistent with hydrothermal gasification of organic matter to form hydrogen, methane and carbon dioxide. Experiments with foam fractionation-derived concentrate with Ru/C catalyst only also showed complete removal of PFOS after 5 h of reactions, suggesting that the complex matrix of the foam fractionate does not inhibit the destructive capabilities of the catalyst. Preliminary analysis also indicated that >50% of the extractable organic carbon was also removed, consistent with past results of Ru/C catalyzing gasification of diverse organic carbon source materials to H₂ and CH₄ under hydrothermal conditions.

### Example 2—Hydrothermal Degradation of Perfluorosulfonic Acids with Ruthenium on Carbon Catalyst

Here, a variety of noble metal and metal oxide heterogeneous catalysts were investigated for their ability to hydrothermally degrade PFSAs in the absence of alkali amendments. Perfluorobutane sulfonate (PFBS) was used in experiments as a model PFSA due to its intermediate hydrophobicity, higher recalcitrance compared to longer chain PFSAs, and growing industrial use (e.g., semiconductor fabrication). One catalyst that performed well in these tests, Ru/C, was also applied for the degradation of PFOS and other PFSAs. Subsequently, a suite of analytical probes were applied to identify reaction products and track the fluorine mass balance. Without wishing to be restricted by theory, Applicants propose a catalytic reaction mechanism and provide insights for future catalyst development that may optimize PFAS destruction and mineralization.

### Materials and Methods

All PFAS analytical standards including isotope-labeled internal standards (IS) were purchased from Wellington Laboratories. Information about all other chemical reagents can be found in Table 1, below.

TABLE 1
reagents

| Reagent | Purity | CAS # | Supplier |
|---|---|---|---|
| NaOH | 97% | 1310-73-2 | Fisher Scientific, USA |
| Ammonium acetate | 98% | 631-61-8 | Fisher Scientific, USA |
| Ammonium hydroxide | Optima grade | 1336-21-6 | Fisher Scientific, USA |
| Methanol | Optima LC-MS grade | 67-56-1 | Sigma-Aldrich, USA |
| Isopropanol | Optima LC-MS grade | 67-63-0 | Sigma-Aldrich, USA |
| Trifluoroethanol | 99.80% | 75-89-8 | Fisher Scientific, USA |
| Water (for LC-MS/MS) | Optima LC-MS grade | 7732-18-5 | Sigma-Aldrich, USA |
| 5% Ruthenium on Carbon | n/a | n/a | Sigma-Aldrich, USA |
| Activated Carbon | n/a | 7440-44-0 | Sigma-Aldrich, USA |
| 5% Palladium on Carbon | n/a | n/a | Sigma-Aldrich, USA |
| Zirconium(IV) Oxide | 99% trace metal basis | 1314-23-4 | Sigma-Aldrich, USA |
| Alumina Oxide | n/a | 1344-28-1 | Sigma-Aldrich, USA |
| Iron(III) oxide-hydroxide | n/a | 51274-00-1 | Bayferrox |
| Titanium Oxide | n/a | 13463-67-7 | ACS Material |
| Sodium Persulfate | >98% | 7775-27-1 | Sigma-Aldrich, USA |
| TISAB | n/a | 1310-73-2 | Fisher Scientific, USA |
| Sodium Acetate | 99% | 127-09-3 | Sigma-Aldrich, USA |
| 1-Butanol | 99% | 71-36-3 | Sigma-Aldrich, USA |
| Sodium trifluoromethane | 98% | 2926-30-9 | Sigma-Aldrich, USA |
| sulfonate (TMFS) | | | |
| Perfluoroethane | 98% | 354-88-1 | Synquest Laboratories |
| sulfonate (PFEtS) | | | Inc |
| Perfluorobutane | 97% | 375-73-5 | Sigma-Aldrich, USA |
| sulfonate (PFBS) | | | |
| Potassium perfluorooctane | >98% | 2795-39-3 | Sigma-Aldrich, USA |
| sulfonate (PFOS) | | | |
| HCl | 30 wt. % in water | 7647-01-0 | Sigma-Aldrich, USA |
| NaF | 99% | 7681-49-4 | Sigma-Aldrich, USA |
| Acetic acid | ≥99% | 64-19-7 | Sigma-Aldrich, USA |

Reactions were conducted in stainless-steel tube batch reactors (1.27 cm outer diameter×10 cm length, 0.12 cm wall thickness, 5.3 mL) using procedures detailed previously. Unless otherwise indicated, reactors were loaded with 100 mg catalyst and 1 mL of a ˜50 mg/L PFSA solution, and sealed reactors were heated by submersion in a fluidized sand bath thermostatted at 350° C. Previous studies confirmed that the reactors reached the target temperature in <5 min. Thus, reactors were held at 350° C. for the allotted time in addition to 5 min of heat up time. Reactors were then removed from the sand bath and cooled to room temperature using a standing fan, and the reactor contents were poured into a 15 mL polypropylene centrifuge tube together with 5 mL of deionized water used for rinsing the reactor. The resulting catalyst/water mixture was centrifuged at 1107 RFC for 10 min before collecting 2 mL of the aqueous supernatant for fluoride analysis. The remaining water/catalyst mixture was then evaporated under N₂ in a 50° C. water bath and dried overnight in an oven set to 50° C. The resulting solid was then extracted 3 times with 13 mL of LC-HRMS grade methanol containing 100 mM ammonium acetate before analyzing. Unless otherwise noted, extraction involved vortexing the spent catalyst in the extractant solution, sonicating for 20 min, and then centrifuging at 1107 RFC for 10 min prior to decanting. All reactions were conducted in duplicate with the standard deviation represented as error.

A separate experiment using elevated initial concentration of PFOS (500 ppm) was conducted to evaluate sulfate release during reactions (to ensure measured amounts in the diluted aqueous supernatant were within the calibration range of the ion chromatography method used for analysis). Furthermore, a separate experiment was also conducted in which spent catalyst (following extraction with methanol) was subjected to HALT conditions (reaction for 2 h at 350° C. with 1 ml of a 1 M NaOH solution) and subsequently analyzed for aqueous fluoride ion.

Fluoride concentrations and pH of post-reaction solutions were measured with an ion selective electrode probe (ISE; Orion Versa Star pH/ISE meter). Aqueous solutions collected for fluoride analysis were diluted using Milli-Q deionized water to obtain an expected concentration within the linear calibration range of the method, and pH was adjusted to 5-5.5 using 10% TISAB buffer. Controls were performed at room temperature and confirmed that the catalyst did not adsorb or leach appreciable fluoride or sulfate ions at room temperature. Fluoride was also qualitatively identified using ¹⁹F-NMR analysis, a detailed description of which is provided below. Filtered samples (0.45 μm PTFE) were also analyzed using ion chromatography with conductivity detection (Dionex ICS-90) for both sulfate analysis and confirmation of fluoride concentrations detected by ISE. Control reactions were also conducted with activated carbon and without catalyst additives to confirm the importance of supported noble metals to observed reactions.

¹⁹F-NMR analysis was conducted on a stock and reacted samples containing initial elevated concentrations of PFOS (500 ppm) in order to analyze within the calibration range. Each sample was the extract of the post reaction spent catalyst and aqueous phase. Reaction times included 1 h and 5 h at 350° C. Sodium trifluoroacetate (0.024 mol-F L⁻¹) was added as an internal standard. Due to a previous study, it was assumed that no internal standard overlap with our intermediates. D₂O was added to samples to lock the field of NMR. Analysis was conduced on a JEOL ECA-500 spectrometer (500 MHz), within a −200 to 900 ppm spectral window. The averaged number of sans was 128 and the acquisition time was 0.544 s. This technique was used for qualitative analysis of our parent compound, intermediates and products.

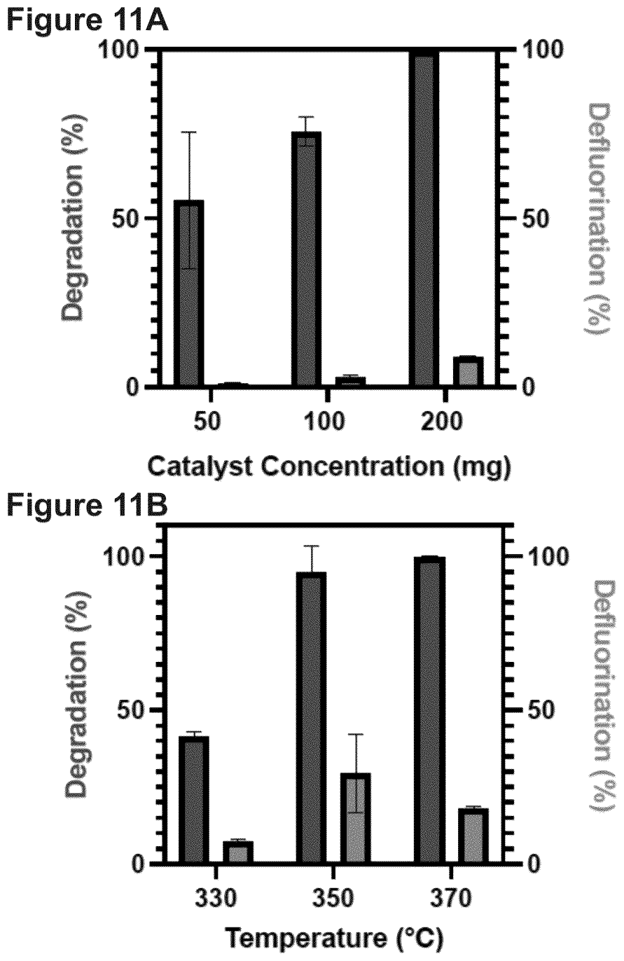

Methanolic extracts were analyzed for residual fluoride or sulfate ions as well as for parent PFAS and potential products. Targeted and nontargeted analyses of PFAS were performed on a UPHLC (Ultimate LPG-3400RS) coupled with an Orbitrap Exploris 240 high-resolution mass spectrometer (Thermo Scientific) following a protocol described previously, and briefly below. MS experimental specifics are detailed in Table 2 below and FIG. 8. PFOS concentrations were also validated in the extracts using ¹⁹F-NMR analysis as described below.

TABLE 2
The details of parameter setting for Orbitrap MS experiment in positive mode.

| Major settings | Details |
|---|---|
| Ion Source | Ion Source Type: H-ESI |
| | Spray Voltage: Static |
| | Positive Ion (V): 3800 |
| | Negative Ion (V): 2500 |
| | Gas Mode: Static |
| | Sheath Gas (Arb): 40 |
| | Aux Gas (Arb): 7 |
| | Sweep Gas (Arb): 2 |
| | Ion Transfer Tube Temp (° C.): 350 |
| | Vaporizer Temp (° C.): 300 |
| | APPI Lamp: Not in Use |
| | Use Ion Source Settings from Tune: False |
| | FAIMS Mode: Not Installed |
| MS Global | Infusion Mode: Liquid Chromatography |
| Settings | Expected LC Peak Width (s): 10 |
| | Advanced Peak Determination: True |
| | Mild Trapping: False |
| | Default Charge State: 1 |
| | Enable Xcalibur AcquireX method modifications: False |
| | Internal Mass Calibration: EASY-IC ™ |
| Full Sean | Orbitrap Resolution: 120000 |
| | Scan Range (m/z): 100-1000 |
| | RF Lens (%): 70 |
| | AGC Target: Standard |
| | Maximum Injection Time Mode: Auto |
| | Microscans: 1 |
| | Data Type: Centroid |
| | Polarity: Positive |
| | Source Fragmentation: Disabled |
| | Use EASY-IC ™: On |
| | Scan Description: |

Sample preparation for PFAS analysis—Each sample before and after the hydrothermal reaction was diluted with LC-MS grade water to ensure that concentrations fall within the PFAS calibration range (5-5000 ng·L⁻¹). Briefly, a 400 μL solution containing 50% of the total volume of the sample, 50% methanol, and 750 μg/mL internal standard was transferred to an HPLC vial for analysis.

PFAS target analysis—Chromatography and Mass Spectrometry—The HPLC system consisted of an autosampler (CTC PAL, CTC Analytics AG) equipped with one six-port high-pressure actuator, one UHPLC pump (Ultimate LPG-3400RS), and a thermostatted column compartment (all from ThermoFisher Scientific, San Jose, CA). The chromatographic separation conditions are as follows: a Gemini C18 analytical column (3 mm×100 mm, 5 μm; Phenomenex, Torrance, CA) with one SECURITYGUARD C18 Guard Cartridge (4 mm×2 mm I.D.; Phenomenex) and two Zorbax DIOL guard columns (4.6 mm×12.5 mm, 6 μm; Agilent, Santa Clara, CA) for ESI− mode. The column oven temperature was set to 40° C. The aqueous mobile phase included two eluents: (A) 20 mM ammonium acetate (Fisher Scientific) in Optima® HPLC-grade water, and (B) 100% Optima® HPLC-grade methanol. Eluent flow rate was 0.60 mL/min, and composition was ramped from 0-0.5 min (90% A, 10% B), 0.5-8 min (50% A, 50% B), 8-13 min (1% A, 99% B), 13-20 min (90% A, 10% B). Mass spectrometry was performed using an Orbitrap Exploris 240 high-resolution mass spectrometer (Thermo Scientific). The mass spectrometer acquired full-scan MS data in negative or positive ionization modes (H-ESI) in separate runs at a resolution of 120,000 over a mass (m/z) range of 150-1500 Da. An internal mass calibration (EASY-IC™) was performed before every sequence and mass accuracy at m/z of 200 was always within 1 ppm. Data-dependent MS2 spectra were acquired for the three most intense ions after each full scan with dynamic exclusion set at 8 s. A targeted mass exclusion list was developed by examining the composition of solvent blanks consisting of water, methanol, 2-propanol, and trifluoroethanol. The exclusion list greatly reduced the fragmentation of ions present in both real samples and blanks. The details of MS experiment are provided in Table 1 and FIG. 8 (see below).

Data Processing. Targeted analysis of PFAS was conducted using TraceFinder™ 5.1 (Thermofisher Scientific) to quantify targeted analytes and identify unknown PFASs from the MS/MS library and NIST list. Confirmation of target analytes with signal:noise ratio >3:1 is based on retention time and accurate mass (XIC window 0.01 Da) compared to analytical standards. The expected retention time for each analyte is set based on a calibration point near the middle of the calibration curve that ran at the beginning of the sequence. The peak detection algorithm is ICIS. The initial parameters include area greater than 1×10⁴, a noise factor of 5, peak noise factor of 10, and a baseline window of 40. Some peaks with peak intensity below the threshold are manually integrated where retention time, accurate mass, and isotope confidence are determined to be satisfactory. Confirmation of targeted analytes is based on retention time and accurate mass compared to analytical standards (<5 ppm). A list of target analytes and internal standards used for quantitation is above. Calibration range, limit of quantitation, and relative standard error (RSE) of calibration curves for all analytes are recorded for each analytical run. If the blanks are all <½ LOQ, the RL will be set as the LOQ. Otherwise, the RL will be set to 3 times the highest blank concentration.

For HALT experiments with spent catalyst, extracted spent catalysts were reacted with 1.1 mL Milli-Q water of 1 N NaOH for 2 h at 350° C. before collecting supernatant for fluoride ion analysis. Spent catalysts were also subjected to the total oxidizable precursor (TOP) assay in an effort to extract bound organofluorine residues. Briefly, the spent catalysts were suspended in a 6 mL solution containing 60 mM sodium persulfate and 120 mM NaOH overnight at 80° C. before diluting, re-extracting, and analyzing with LC-HRMS. Base containing reactions and TOP assay was performed in 25 mL stainless steel parr batch reactors, as they are more resistant to corrosion-related failure.

Residual surface bound fluorine was also measured using particle-induced gamma-ray emission (PIGE) spectrometry. Spent extracted catalysts were compared against fresh catalyst with physiosorbed PFBS. Experiments conducted for PIGE analysis contained 500 mg catalyst and 5 ml 500 mg/L PFSA to obtain enough sample volume for analysis. Analysis was conducted as described previously¹⁹ and information is provided in Section B4 of Appendix B.

Swagelok tubes fitted with gas release valves were used for sampling of the reactor headspace post-reaction. Following 5 h hydrothermal reaction of 100 mg catalyst and 1 ml of deionized water with 500 mg/L PFOS, gas was removed from the reactor using a 500 ml gastight syringe and injected directly into gas chromatograph (GC) instruments. Gas analysis was conducted using both a gas chromatograph with mass spectrometry detection (GC-MS, Thermo TRACE GC coupled to a Thermo DSQ II quadrupole mass spectrometer), and a gas chromatograph with thermal conductivity detector (GC-TCD, Thermo Fisher, TRACE 1310). Analysis methods were conducted as described in Hao et al., Hydrothermal Alkaline Treatment for Destruction of Per- and Polyfluoroalkyl Substances in Aqueous Film-Forming Foam. Environ. Sci. Technol. 2021, 55 (5), 3283-3295 (doi.org/10.1021/acs.est.0c06906). Standards for PIGE analysis were prepared through room temperature PFBS sorption onto 5 mg of GAC in 5 ml PFBS solution containing between 125-500 mg F/kg catalyst. Spent catalysts analyzed using PIGE were reacted for 3 h at 350° C. with 5 mg catalyst and 5 ml 60 mg/L PFBS. Spent catalysts were removed, extracted, and dried before being sent for analysis. Fresh RuC was used as a blank. All samples were analyzed in small plastic baggies. The calibration curve generated by the standards was used to quantify fluorine on the spent catalysts.

### Results

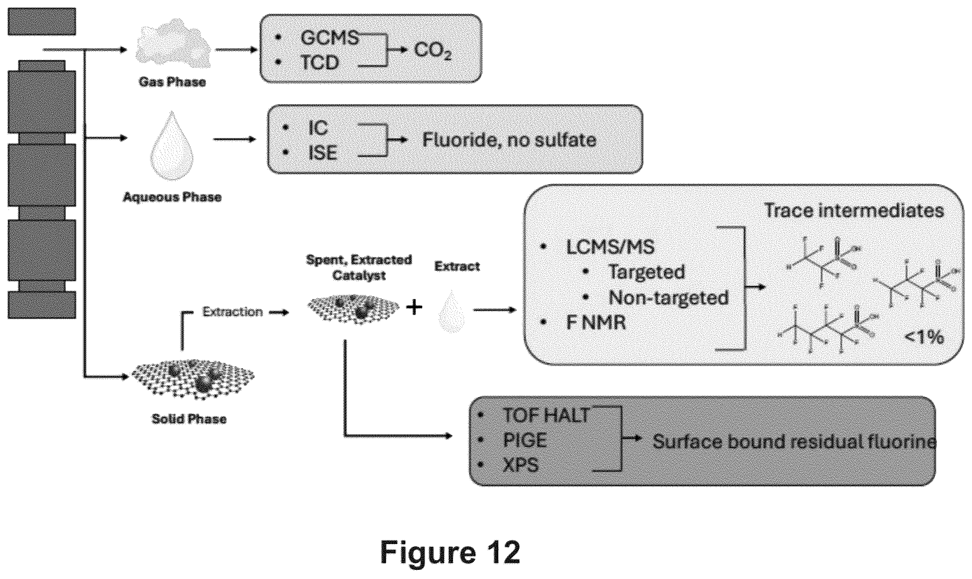

Applicants screened a series of heterogeneous catalysts for potential hydrothermal reactions of PFBS, including both noble metals supported on carbon and metal oxide materials. See Table 3 below. Results from the screening show that carbon-supported noble metal catalysts, Ru/C and Pd/C, promoted significant degradation and partial defluorination compared to metal oxides. Ru/C was particularly successful at removing and degrading PFBS, with >93% removal and >21% defluorination being observed after 5 h of reaction. Control reaction with a metal-free activated carbon material showed no degradation or defluorination of PFBS, indicating reaction occurs on the supported noble metal (FIG. 9). Activated carbon is a known adsorbent for PFAS. Therefore, for those catalysts containing a carbon support, an extraction procedure was validated to confirm that adsorbed PFBS would not mislead treatment data. Further, a reaction with a commercial activated carbon material yielded full recovery of PFBS, suggesting the hydrothermal treatment did not interfere with the ability to recover remaining PFSA using the extraction protocol. Thus, we expect all residual PFBS to be extractable from our spent catalyst. Controls also validated that all tested catalysts adsorb a negligible amount of fluoride or sulfate at conditions used in experiments. Moreover, controls showed negligible leaching of fluoride or sulfate ions from the catalyst materials. Thus, we expected majority of any fluoride and sulfate ions released from parent PFSA to be present in the aqueous phase of post-treatment reaction mixtures.

TABLE 3
Catalyst Screening of PFBS degradation

| Catalyst | Reaction Time (hours) | % defluorination |
|---|---|---|
| No catalyst | 3 | 3.5 |
| 1% Ir/C | 1 | 15 |
| | 3 | 19.5 |
| | 5 | 49.9 |
| 5% Pt/C | 1 | 7.7 |
| | 3 | 9.5 |
| | 5 | 25.5 |
| 5% Rh/C | 3 | 20.5 |

Reaction Conditions: 1 ml of 60 mg/L (0.2 mM) PFBS at 350° C.

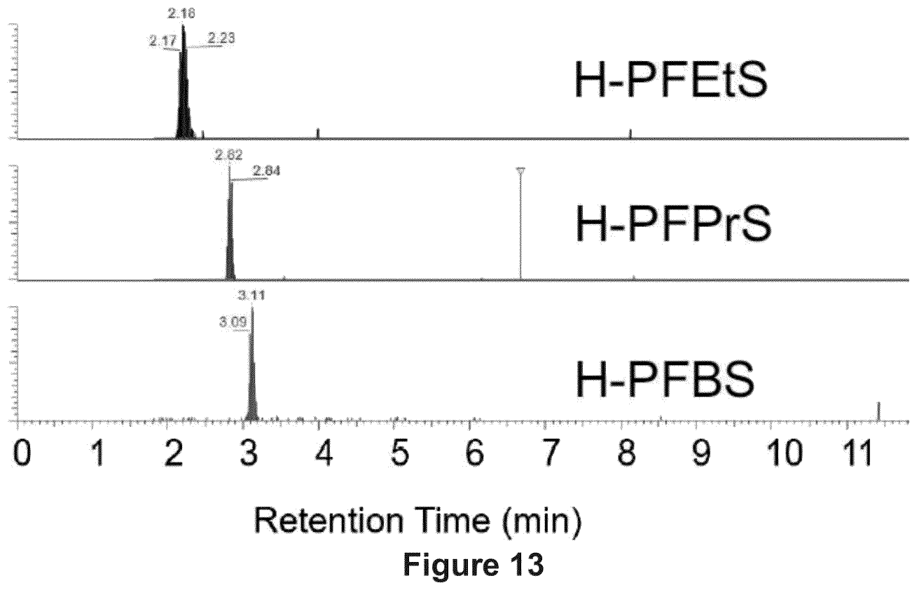

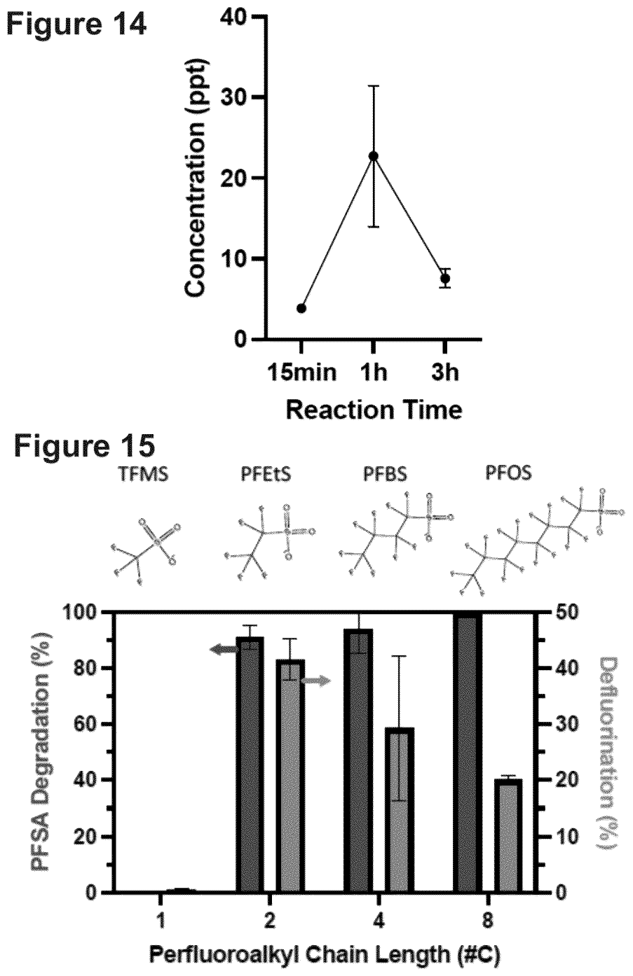

The performance of Ru/C merited supplementary study into its potential as a promoter for the hydrothermal destruction of PFSAs. The subsequent PFSA chosen for degradation analysis was PFOS, since it has a more significant environmental prevalence than PFBS and a stricter EPA MCL of 4 ng/L. Thus, time sequenced experiments were conducted using Ru/C for destruction of both PFBS and PFOS. In the presence of Ru/C, PFBS and PFOS are respectively removed 83% and 76% from the solution after 15 min of hydrothermal treatment. After 3 h, >93% removal is achieved for both compounds (FIG. 10A-C). Following 5 h of reaction time, maximum fluoride release of >21% is reached for both PFBS and PFOS. No further release of fluoride was observed after 10 h. Temporal defluorination of PFOS was confirmed by ¹⁹F-NMR (FIG. 10A-C). Interestingly, separate experiments initiated with elevated concentrations (500 mg/L) of PFOS show no release of sulfate following reaction. These findings contrast with the stoichiometric releases of fluoride and sulfate observed for hydrothermal alkaline treatment. Catalyst loading was also varied, and revealed a positive correlation of concentration with both PFBS defluorination and removal (FIG. 11A). Variations in reaction temperature were also tested. Interestingly, temperatures above 350° C. resulted in a similar amount of PFBS degradation, but a lower amount of defluorination (FIG. 11B). Comparatively, 330° C. resulted in both lower degradation and defluorination, likely resulting from the high thermal activation energy necessary for this reaction. The lower than expected defluorination at the highest reaction temperature is attributed to either experimental variation or expedited catalyst deactivation at the higher temperature.

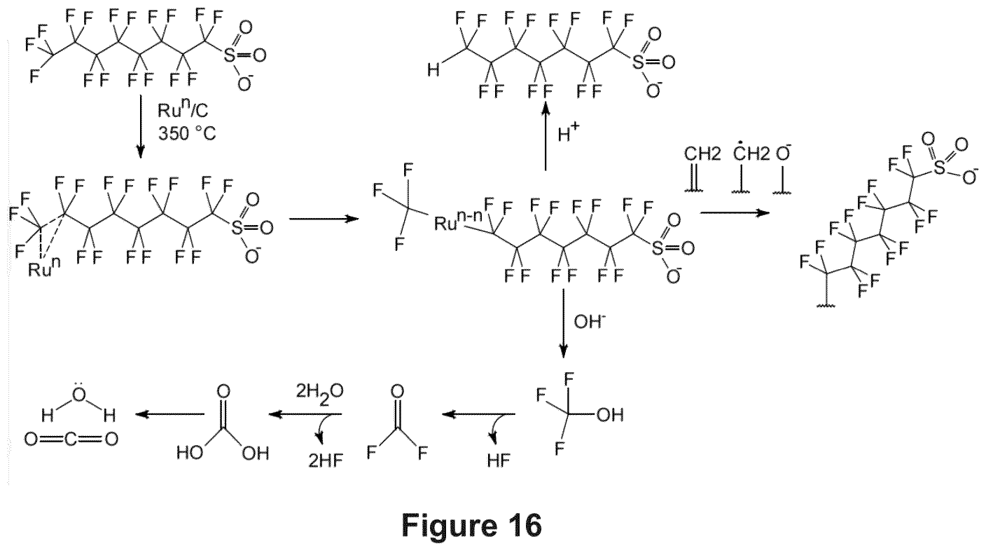

Reacted samples included aqueous, solid, and gas phases. Analysis of each of these phases is discussed here and, for reference, FIG. 12 is a detailed schematic mapping the analytical processes performed. Following reactions with PFAS, the aqueous phase was analyzed for fluoride and sulfate recovery as described previously. For experiments over Ru/C, partial fluoride (0%<x<30%) and no sulfate generation was detected. While not the case for inorganic products, controls did reveal adsorption of both PFBS and PFOS to Ru/C at room temperature. LC-HRMS was performed on the aqueous phase to confirm full surface adsorption of PFSAs and any detectable organic transformation products. No detectable parent compounds were found in the aqueous phase, confirming the need for extraction prior to analysis of residual PFAS and organic intermediates/products.

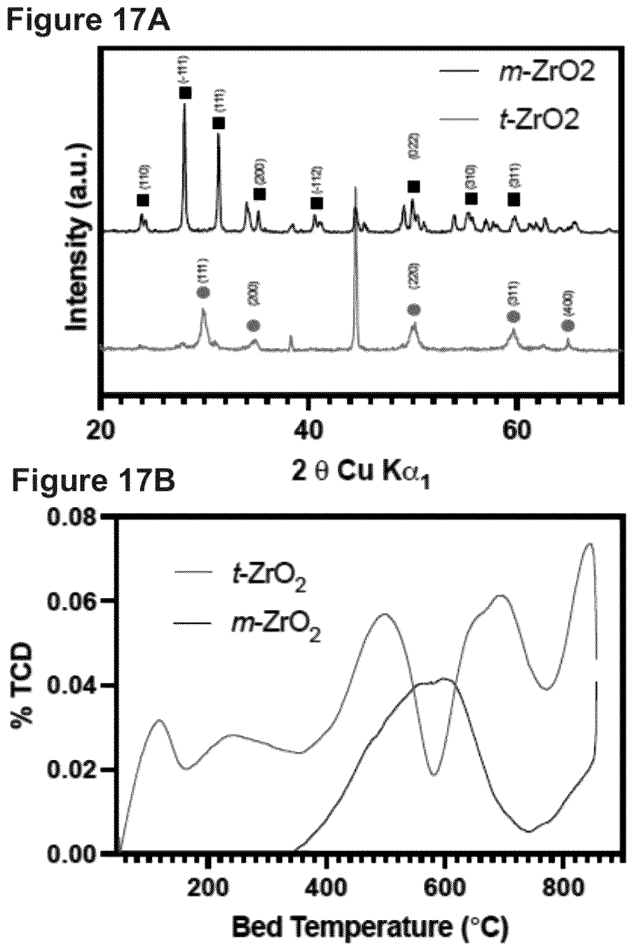

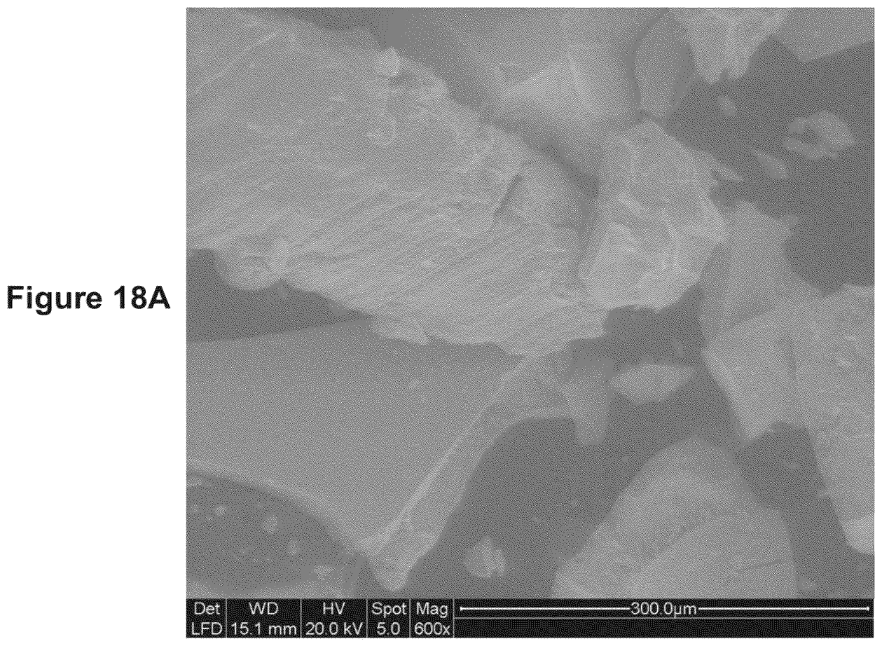

The applied extraction procedure was validated to recover >85% all physiosorbed PFOS and >99% all physiosorbed PFBS. First, targeted LC-HRMS and ¹⁹F-NMR were used to analyze extracts for parent PFSA residuals and transformation products. Neither technique found products other than fluoride and/or residual PFSA starting reagent (FIG. 10A-C). Interestingly, the gap between PFSA removal and fluoride recovery, shown in FIG. 10A-C, suggests the production of fluorinated organic intermediates. Further, the gap between fluoride generation and sulfate generation suggests that such fluorinated species also retain the sulfonate headgroup. Subsequently, we analyzed spent catalyst extracts for presence of organic intermediates using orbitrap Exploris 240 non-targeted analysis. In the 15 min and 1 h reacted samples, nontargeted analysis identified multiple partially fluorinated sulfonates in the extracts (Table 4, FIG. 13). 1,1,2,2,3,3,4,4-Octafluorobutane-1-sulphonic acid (C₄H₂F₈O₃S) was run as a standard for confirmed qualification of the intermediate having a C₄H₂F₈O₃S structure. Extrapolated semi-quantification performed with this reference standard suggests that the concentrations of this intermediate and the others represent <1% of the total PFOS loss, which is lower than the LOD for ¹⁹F-NMR analysis (FIG. 14). Thus, it is not surprising that NMR spectra (FIG. 10C) show no evidence of such organic intermediates in extracts. It should be noted that the exact location of the hydrogen substituted fluorine was not identified but is suspected to be located on the terminal carbon in the fluorinated chain considering the proposed mechanism that will be discussed below.

TABLE 4
Trace intermediate products

| | |
|---|---|
| C₄H₂F₈O₃S (H-PFBS) | 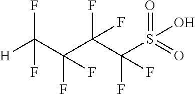 [SMILES: O=S(=O)(O)C(F)(F)C(F)(F)C(F)(F)C(F)F] |
| C₃H₂F₆O₃S (H-PFPrS) | 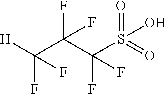 [SMILES: O=S(=O)(O)C(F)(F)C(F)(F)C(F)F] |
| C₂H₂F₄O₃S (H-PFEtS) | 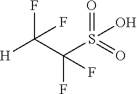 |

The lack of significant quantities of intermediates in both the aqueous supernatant and solid extracts indicated that the remaining fluorine transferred to either the solid surface or gas phase following reaction. In further attempts to desorb and identify intermediates, we elongated the standing extraction procedure by replacing the three 20 min sonication steps with three 24 h 140 rpm shaker table agitation steps. We also substituted the 100 mM ammonium acetate in methanol extractant solution for basic methanol and butanol, but none of these modifications increased desorption of the intermediates. We then conducted a supplementary rinse of our spent catalyst which had been hydrothermally reacted for 10 h with PFOS. The rinse was performed with a 20 mM sodium acetate solution using an SPE vacuum manifold, which has been shown to be successful for fluoride removal from activated carbon. Three 6 mL washes were able to recover a total of 3% recovery of fluoride, and no recovery of sulfate, PFOS, or any intermediates (FIG. 14). Lastly, we conducted a total oxidizable precursor (TOP) assay of our spent and extracted catalysts. TOP assays are used for samples with high concentrations of unidentifiable PFAS precursors or intermediates which common EPA analytical methods are not sensitive to. During the treatment, oxidizable precursors are exposed to heat and undergo alkaline activated persulfate oxidation, where generated radicals convert unidentified species into traceable perfluoroalkyl acids. Still, subjecting the material to TOP assay yielded no additional PFSA or fluoride, indicating that fluorinated intermediates are strongly bound and not easily released into solution.

Previously, our group developed a procedure, hydrothermal alkali treatment (HALT), which is able to fully mineralize fluorinated organics including those adsorbed to activated carbon. To continue to rule out the production of gaseous fluorinated organics, we performed HALT on the spent, extracted catalyst removed from a 5 h hydrothermal rection with PFBS. This HALT reaction released an additional 68% of the initial fluorine content of PFBS to solution. When combined with the initial defluorination of PFBS observed for alkali-free reaction with Ru/C (32%), this brought the fluoride accounted for up to ˜100%. These results support a conclusion that the fluorine-containing residuals resulting from Ru/C reaction are chemisorbed to the catalyst surface rather than gas phase in nature. These results were supported by preliminary results showing only CO₂ being qualitatively identifiable by both GC-MS and GC-TCD in the post-reaction headspace. However, future work will be conducted to quantify all products in the headspace.

Finally, methanol-extracted catalysts (FIG. 12) were analyzed for total fluorine content by Particle Induced Gamma-ray Emission spectroscopy (PIGE), positively confirming the presence of significant quantities of fluorine on the reacted and extracted Ru/C samples. Analysis yielded a signal consistent with 31% of the fluorine in the initial added PFBS. While this quantity is less than that determined by fluoride ISE following HALT, this measurement positively confirms the presence of unextractable fluorine species on Ru/C following reaction.

It should be noted that this is not the first report of intermediate loss due to proposed catalytic binding of PFSAs and/or their intermediates. In 2018, Park et al. proposed the complexation of PFOS with Pd⁰/nFe⁰ nanoparticles, specifically a Fe(OH)₃ intermediary reactant, limiting extractability and leading to losses that could be misperceived as degradation. In that work, they postulate, as a result of their negligible fluoride and sulfate recovery, that all PFOS removal is due to parent compound sorption and no degradation is occurring. In this prior study, the complexation losses varied significantly with chain length (e.g., ˜60% for PFOS, ˜0% PFBS). They also did not observe a significant correlation between temperature (22° C.-70° C.) and coordination removal. Conversely, we observe equal fluoride mass loss between PFOS and PFBS. Further, room temperature sorbed PFSAs were able to be completely desorbed by extraction with methanol/ammonium acetate mixture. Thus, we conclude that fluorinated organic reaction products chemisorb to the Ru/C surface.

Collectively, analyses of the aqueous phase, methanolic extracts, and post-extraction catalyst material indicate formation of strongly bound organic fluorine species that retain the sulfonate headgroup and the majority of the initial PFSA-bonded fluorine. LC-HRMS analysis of extracts did show small quantities of a series of mono-H-substituted PFSA intermediates that are shorter chain length than the starting PFSA reagent.

Without wishing to be restricted by theory, Applicants hypothesize that the described findings may be consistent with a proposed catalytic mechanism wherein PFSA degradation is initiated by homolytic cleavage of carbon-carbon bonds along the perfluoroalkyl chain. Here, Applicants hypothesize that the proposed mechanism may be similar to ruthenium-catalyzed hydrothermal gasification reactions of biomass derived feedstocks. Here, Applicants propose that homolytic cleavage of the terminal F₃C—CF₂R bond yields ·CF₃ and a ·CF₂R radical-terminated PFSA that is one carbon shorter. The ·CF₃ is expected to be highly unstable and will rapidly hydrolyze in water releasing fluoride and HCO₃⁻. The ·CF₂R sulfonate species is also unstable. It can abstract a hydrogen from water to produce a mono-H-substituted PFSA species consistent with the small quantities of organic products detected in extracts by LC-HRMS. Alternatively, a majority of these species may react with reduced groups on the carbon support to form covalently bonded PFSA species that are not amenable to solvent extraction.

Ruthenium catalyzed C—C cleavage mechanisms may include oxidative addition, which occurs through activation of the Cₙ-Cₙ₋₁ bond, attracting each carbon to an unoccupied surface site, weakening the bond and resulting in homolytic cleavage. Metal insertion to the Cₙ-Cₙ₋₁ bond is common in electron rich group 8 metal reactions. While transition metal reactive chemistry with alkanes has been well established, the number of studies regarding fluoroalkanes is limited. However, the process of pyrolysis has been shown to crack fluoroalkanes, and mechanism of pyrolysis is expected to be similar over Ru/C. Extending this idea to fluoroalkanes would support that Ru/C drives similar C—C cleavage as is done in non-halogenated alkanes.

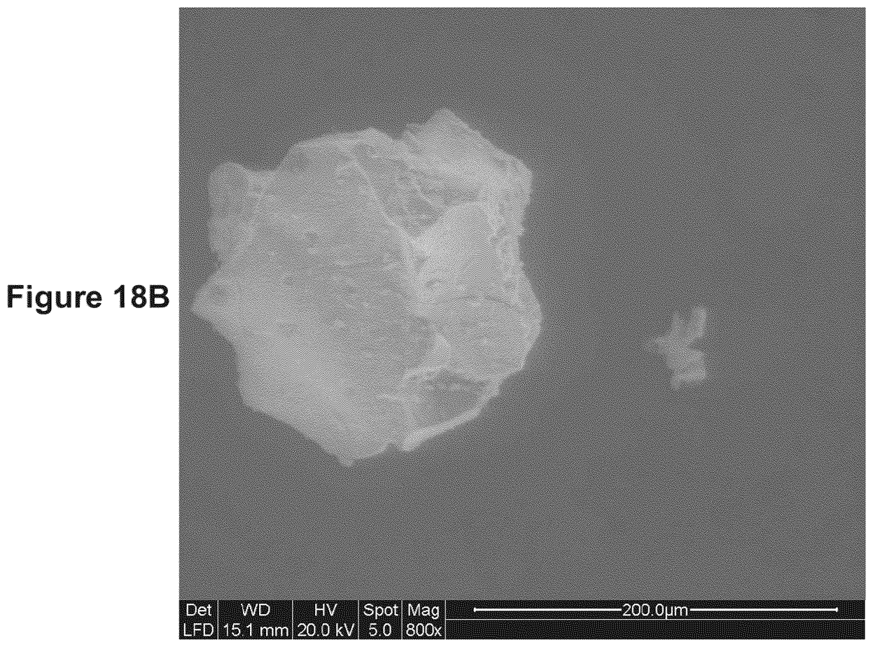

The proposed mechanism is consistent with the fact that no sulfate or sulfite is detected in the reacted aqueous solutions, and therefore is suspected to remain associated with the bound species. Moreover, comparison of reactions using PFSAs of varying chain lengths shows no degradation or defluorination of trifluoromethane sulfonate (TFMS), the C1 PFSA that lacks any C—C bonds, whereas significant degradation and defluorination is observed for the C2-C8 PFSAs (FIG. 15). Further, the increasing extent of defluorination observed for shorter chain PFSAs is consistent with the greater fraction of fluorine bonded to the terminal C—C groups being preferentially cleaved and subject to hydrolytic release of fluoride.

The detection of multiple mono-H-substituted PFSAs of varying chain length in aqueous solution, albeit in small quantities, suggests that some of the ·CF2R intermediates may undergo further C—C cleavage reactions before being released to solution or forming covalently bound species with Ru/C. The fact that the extent of defluorination remains unchanged after 10 h of reaction suggests that bound residuals are inert to further catalytic reaction. However, these species are amenable to reaction with added alkali, similar to PFAS physiosorbed to activated carbon.

### Example 3—Tailoring Metal Oxide Catalysts for Hydrothermal Destruction of PFAS Catalyzed by Tetragonal ZrO₂

This example presents experiments on the subcritical hydrothermal degradation and mineralization of PFAS over zirconium dioxide (ZrO₂) catalysts. The present results demonstrated that a tetragonal ZrO₂ (t-ZrO₂) was able to mineralize perfluorobutane sulfonic acid (PFBS), a highly recalcitrant perfluoroalkyl sulfonic acid (PFSA), within about 3 h of treatment (350° C., 20 MPa), releasing stoichiometric quantities of F⁻ and SO₄²⁻; non-targeted high resolution mass spectrometry analysis revealed no stable organic byproducts. In comparison, monoclinic ZrO₂ (m-ZrO₂) showed little reactivity with PFBS and no formation of F⁻ and SO₄²⁻ mineralization products within 5 h of reaction at the same conditions. Further tests with t-ZrO₂ showed similar reactivity and mineralization of the corresponding C1 and C8 PFSAs as well as perfluorooctanoic acid (PFOA), a C8 perfluoroalkyl carboxylic acid (PFCA). Although PFOA and other PFCAs degrade non-catalytically in hydrothermal water via thermally driven decarboxylation, F⁻ release is only observed when t-ZrO₂ is present. The observed products and trends for PFSAs and PFOA are consistent with those documented for homogeneous hydrothermal reactions mediated by concentrated alkali, where the active mechanism involves nucleophilic substitution reactions leading to PFAS mineralization. The variable reactivity observed for t-ZrO₂ versus m-ZrO₂ is attributed to differences in abundance and strength of basic surface sites. These findings provide a path forward for development of effective amendment-free catalytic destruction technologies for highly recalcitrant PFAS water contaminants.

### Materials and Methods

All PFAS analytical standards including isotope-labeled internal standards (IS) were purchased from Wellington Laboratories. A commercially sourced ZrO₂ material, characterized to be in the monoclinic phase, was purchased from Sigma Aldrich. Information about all other chemical reagents can be found in the Table 4 below.

TABLE 4
reagents

| Reagent | Purity | CAS # | Supplier |
|---|---|---|---|
| Sodium Hydroxide | 10N/Certified | 1310-73-2 | Fisher Scientific, USA |
| Sodium Carbonate | >99.5% | 497-19-8 | Fisher Scientific, USA |
| Methanol | Optima LC-MS grade | 67-56-1 | Sigma-Aldrich, USA |
| Isopropanol | Optima LC-MS grade | 67-63-0 | Sigma-Aldrich, USA |
| Trifluoroethanol | 99.80% | 75-89-8 | Fisher Scientific, USA |
| Water (for LC-MS/MS) | Optima LC-MS grade | 7732-18-5 | Sigma-Aldrich, USA |
| Zirconium(IV) Oxide | 99% trace metal basis | 1314-23-4 | Sigma-Aldrich, USA |
| TISAB | n/a | 1310-73-2 | Fisher Scientific, USA |
| Zirconium(IV) | >99.9 | 14985-18-3 | VWR Scientific |
| oxynitrate hydrate | | | |
| Sodium | 98% | | |
| trifluoromethane | | 2926-30-9 | Sigma-Aldrich, USA |
| sulfonate (TMFS) | | | |
| Perfluoroethane | 98% | 354-88-1 | Synquest Laboratories Inc |
| sulfonate (PFEtS) | | | |
| Perfluorobutane | 97% | 375-73-5 | Sigma-Aldrich, USA |
| sulfonate (PFBS) | | | |
| Potassium | >>98% | 2795-39-3 | Sigma-Aldrich, USA |
| perfluorooctane | | | |
| sulfonate (PFOS) | | | |
| Perfluorooctanoic acid | 95% | 335-67-1 | Sigma-Aldrich, USA |
| (PFOA) | | | |
| NaHS | >>67% | 207683-19-0 | Fisher Scientific, USA |
| KI | >98% | 7681-11-0 | Fisher Scientific, USA |
| HCl | 30 wt. % in water | 7647-01-0 | Sigma-Aldrich, USA |
| NaF | 99% | 7681-49-4 | Sigma-Aldrich, USA |
| D₂O | 99.96 atom % D | 7789-20-0 | Sigma-Aldrich, USA |
| Ammonium acetate | Optima LC-MS grade | 631-61-8 | Fisher Scientific, USA |
| Ammonium hydroxide | Optima grade | 1336-21-6 | Fisher Scientific, USA |
| Methanol | Optima LC-MS grade | 67-56-1 | Fisher Scientific, USA |
| Isopropanol | Optima LC-MS grade | 67-63-0 | Fisher Scientific, USA |
| Trifluoroethanol | 99.80% | 75-89-8 | Fisher Scientific, USA |
| Water (for LC-MS/MS) | Optima LC-MS grade | 7732-18-5 | Fisher Scientific, USA |
| Acetic acid | ≥99% | 64-19-7 | Sigma-Aldrich, USA |
| Heneicosanoic acid | ≥99% | 2363-71-5 | Fisher Scientific, USA |

Tetragonal ZrO₂ was synthesized using a precipitation method adapted an earlier report. In a 1 L round bottom flask, 400 ml of a 0.16 M solution of zirconium (IV) oxynitrate hydrate in water and 350 ml of a 0.3 M NaOH and 0.08 M Na₂CO₃ solution in water were mixed at 900 rpm on a stir plate overnight, yielding a slurry with a pH of 9.5. The slurry was then filtered through a Whatman grade 1 qualitative filter and rinsed with deionized water. The collected solid was then placed in a ceramic mortar and heated overnight at 110° C. to dry. The dried solid was then ground with a pestle to a powder and calcined in a muffle furnace at 600° C. for 4 h with a 1 h ramp time. The calcined solid was then transferred to a quartz boat and activated in a tube furnace under H₂ flow at 650° C. for 1 h with a 1 h ramp time (˜10° C./min). Finally, the activated ZrO₂ material was rinsed with water using vacuum filtration setup.

Phase composition of the commercially sources and synthesized ZrO₂ phases were determined by X-ray diffraction (XRD, PANalytical PW3040 X-ray diffractometer) between 20-70° (2q) at a scan rate of 37° min⁻¹. Specific surface area was determined by N₂ physisorption analysis (Micromeritics Tristar 3020). Adsorption-desorption isotherms were recorded at 77 K after the samples were degassed under vacuum at 100° C. at a ramp rate of 15° C./min and held for 5 h. Temperature programmed desorption (TPD) of adsorbed NH3 or CO₂ was conducted using a AMI-300 from Altamira Instruments. Desorption spectra were collected over a heating profile of 45-850° C., after pretreating at 350° C. and sparging with CO₂ for 60 min at room temperature. Scanning Electron Microscopy (SEM) was conducted on an FEI quanta 6001 environmental SEM equipped with Energy Dispersive Spectroscopy of X-rays (EDS) under low vacuum (0.1-1 torr).

Batch hydrothermal reactions were conducted in 25 ml stainless steel Parr reactors (model number 4740). Unless otherwise noted, reactors were loaded with 100 mg catalyst and 1 ml aqueous solution containing 0.2 mM concentration of the target PFAS. Reactors were then sealed and immersed in a fluidized sand bath pre-heated to the target reaction temperature (model number FTBLL12W). After reaction for the desired time period, reactors were removed from the heat source and air-cooled for ˜1 h using a fan before opening and collecting the reactor contents for analysis. The reactor was also rinsed with deionized water, and the initial sample plus rinsate were collected and further diluted to 14 ml in a 15 ml polypropylene centrifuge tube before analysis. Prior to analysis, the sample was centrifuged for 10 min at 878 RFC for separation of solids. Control reactions were performed in the same manner without addition of catalyst.

Post reaction pH of the diluted sample was recorded and then adjusted to pH 5-5.5 for fluoride ion analysis using 10% TISAB. Aliquots removed for fluoride analysis were diluted using deionized water. Fluoride concentrations and pH were measured with an ion selective electrode probe (Orion Versa Star pH/ISE meter). Samples for sulfate analysis were filtered through a 0.45 μm PTFE filter and analyzed using ion chromatography (IC). Tests conducted at room temperature showed negligible adsorption of the PFAS, F⁻, and SO₄²⁻ to the ZrO₂ solids at the catalyst loading and initial PFAS concentrations used in this study.

Targeted and nontargeted analyses of PFAS were performed on a UPHLC (Ultimate LPG-3400RS) coupled with an Orbitrap Exploris 240 high-resolution mass spectrometer (Thermo Scientific) following a protocol described previously.

### Results

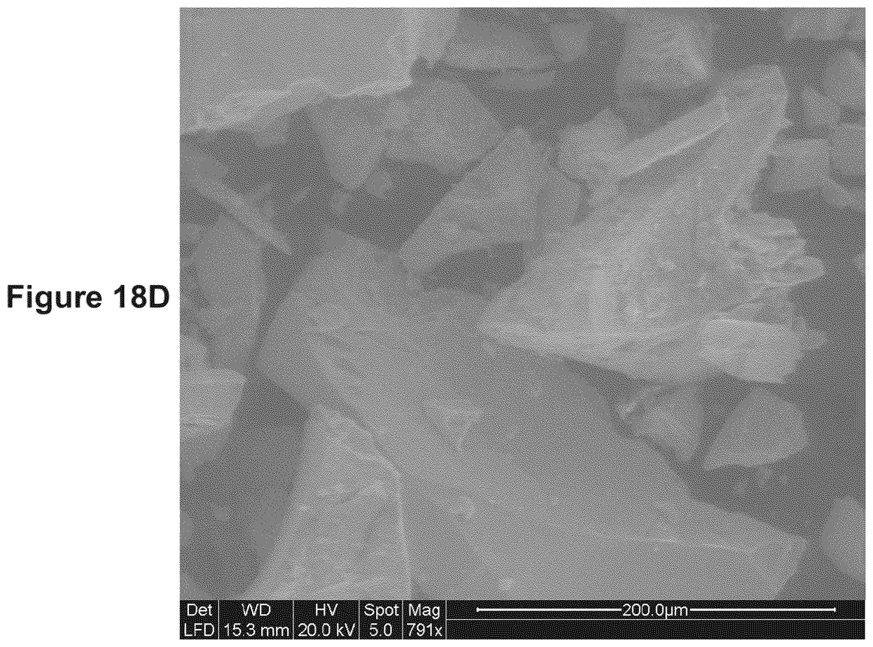

Powder XRD analysis confirmed that the commercially sourced ZrO₂ has a monoclinic structure (m-ZrO₂), whereas the ZrO₂ synthesized inhouse exhibited primarily a tetragonal phase ZrO₂ (t-ZrO₂) (FIG. 17A). The presence of a t-ZrO₂ phase is indicated by diffraction peaks at 28 of 30.2°, 50.4°, 50.6°, and 60.0°, representing the (101), 112), (200), and (311) planes, respectively. Distinguished m-ZrO₂ peaks are traditionally observed at 28=28.7° and 34.2°, signifying the (1=11) and (111) phases, respectively.

N₂ physisorption measurements indicated BET specific surface area for m-ZrO₂ and t-ZrO₂ of 5 m² g⁻¹ and 10 m² g⁻¹, respectively. Reports from literature show specific surface areas for m-ZrO₂ ranging from 5 to 50 m² g⁻¹, whereas values reported for t-ZrO₂ range anywhere up to 400 m² g⁻¹. The lower surface area of the t-ZrO₂ synthesized in this study was attributed to the high calcination temperature used (600° C.). t-ZrO₂ is normally unstable at ambient conditions when the crystal size is above 20 nm, however, relatively low surface area suggests the presence of large crystallites.

CO₂ TPD measurements revealed the presence of over three times as many basic sites on t-ZrO₂ (362 μmol/g) compared to m-ZrO₂ (120 μmol/g). Interestingly, t-ZrO₂ also contains a greater concentration of CO₂ desorption peaks over a wider range of temperatures than m-ZrO₂. This indicates a wider distribution of base site strengths for the former, whereas that latter is dominated by sites that are characterized more explicitly as moderately strong and strong base character (FIG. 17B). Further, t-ZrO₂ is unique in containing CO₂ desorption peaks at or below the temperature of operation (350° C.).

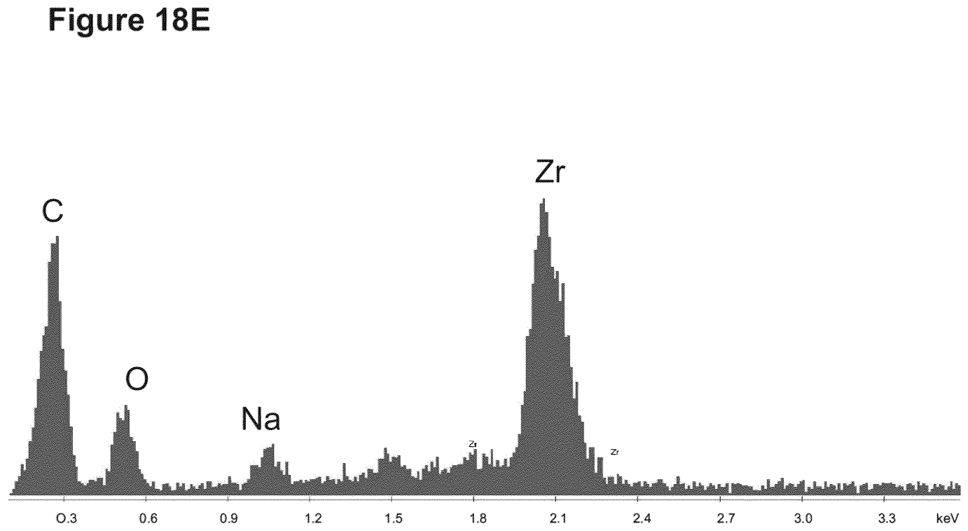

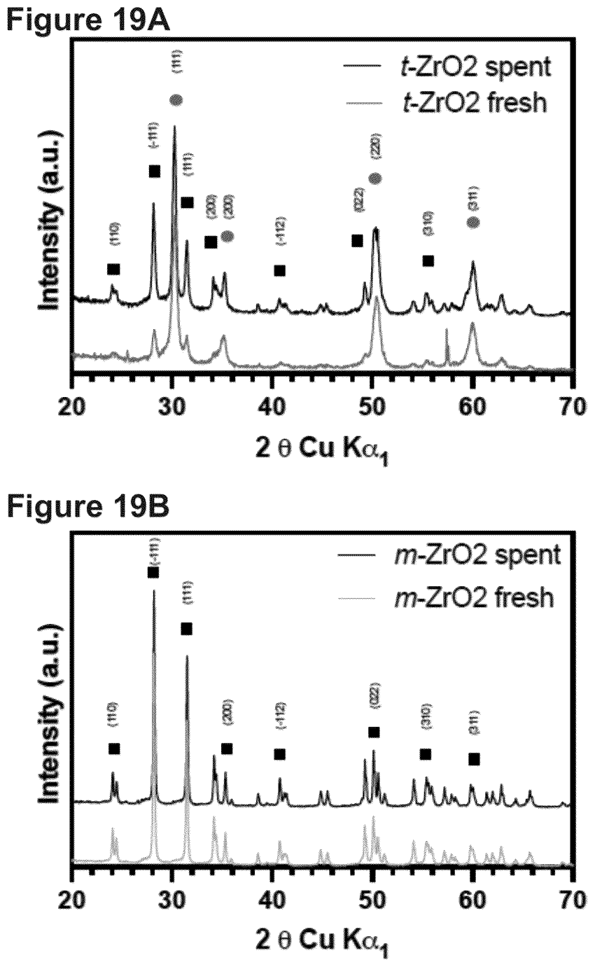

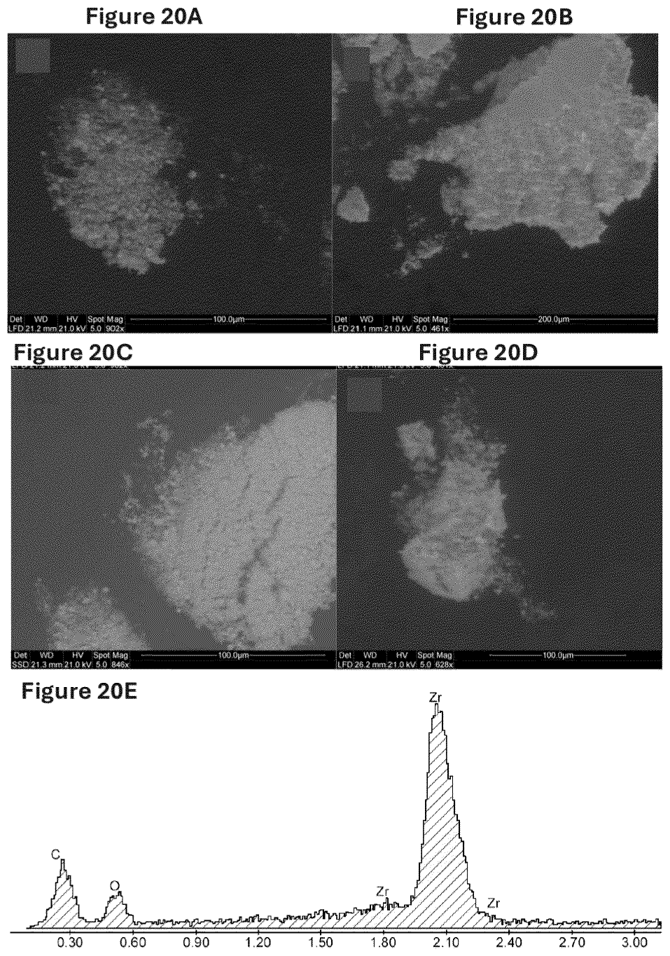

FIG. 18A-E shows scanning electron micrographs and energy dispersive spectra (SEM-EDS) collected for the synthesized t-ZrO₂. The images show large agglomerates of ZrO₂ crystallites, which also explains low surface area measurements (FIG. 18A-D). In addition to expected EDS peaks for Zr and O (and C for the carbon adhesive holding the sample to the support of the microscopy sample holder), there is a significant peak associated with Na (FIG. 18E). The presence of this peak despite repeated washing of collected solid with deionized water suggests some level of incorporation in the t-ZrO₂ surface structure occurs during the sol gel precipitation procedure. Past reports suggest that surface doping with Na can stabilize formation of the tetragonal ZrO₂ phase and prevent sintering and subsequent phase transformation during high temperature calcination and activation treatments. This could provide reasoning for the stabilization of the large crystallites of the tetragonal phase. FIG. 19A-B shows the expansion of the monoclinic phase following 6 h hydrothermal reaction of t-ZrO₂. Interestingly, sodium was found in the aqueous phase of these post-reacted samples, suggesting Na leaching that may have contributed to polymorphic transformation. Comparatively, FIG. 20A, FIG. 20B, FIG. 20C, and FIG. 20D show the SEM images and FIG. 20E an EDS for fresh m-ZrO₂. The morphology is more smooth and spherical, and there is no sodium identified by EDS.

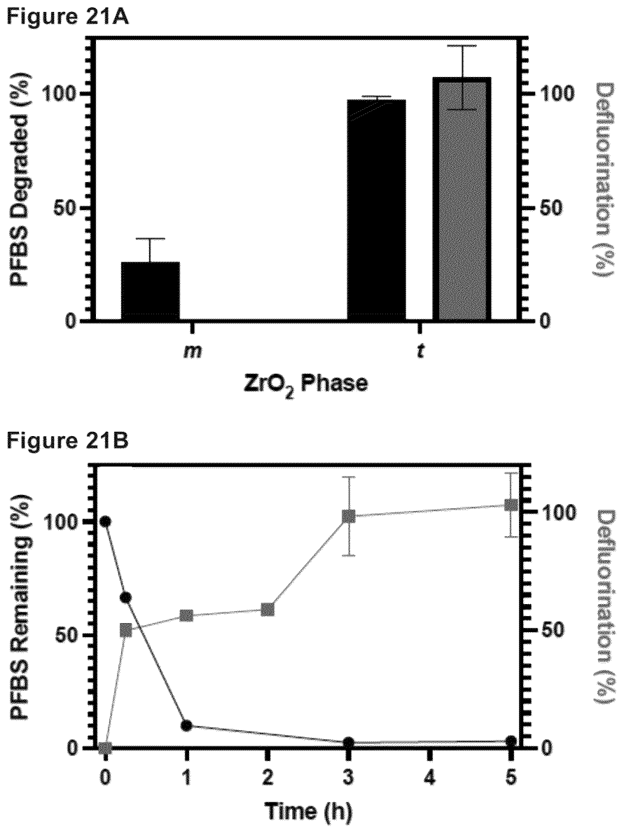

As already mentioned, ZrO₂ materials have been documented as being catalytically active and structurally stable phases in near-critical water. Here, we compared catalytic activity of the two ZrO₂ phases during subcritical hydrothermal degradation and defluorination of PFBS, a short-chain perfluoroalkyl sulfonic acid (PFSA) (FIG. 21A). PFSAs were selected for catalytic testing because this class of PFAS have been found to be most recalcitrant during hydrothermal alkaline treatment studies. As we reported previously in wider screening of catalyst materials experiments, tests with m-ZrO₂ resulted in only a small fraction of PFBS lost from solution and negligible degree of defluorination following 3 h of reaction, with measured fluoride ion concentrations being below the limit of detection for the ion selective electrode probe (0.002 mg/L). In comparison, tests with t-ZrO₂ showed markedly higher activity, with >98% loss of the added PFBS and release of 39.2 mg/L F⁻ (corresponding to ˜107% defluorination of the added PFBS) after 3 h of reaction. Analysis of the reacted solutions also showed formation of 203 mg/L SO₄²⁻, consistent with stoichiometric release from the added PFBS (˜105% of the sulfur content of the added PFBS), note that reactions analyzed for sulfate removal were conducted at elevated concentrations to remain within the calibration range of the ion chromatography method. Further kinetics experiments were conducted with t-ZrO₂ (FIG. 21B), showing rapid depletion of PFBS during the first 15 min of reaction with release of a near stoichiometric quantity of F⁻. Although there is some discrepancy between the extent of PFBS degradation and F⁻ release observed at t=1 h, suggesting formation of some stable fluorinated reaction intermediates, ¹⁹F-NMR and non-targeted LC-orbitrap-HRMS analysis of the reaction solutions failed to identify any fluoro-organic structures other than PFBS. These findings are similar to homogeneous hydrothermal alkaline treatment (HALT) reactions of PFSAs initiated by concentrated OH—, where the proposed initial 1H-perfluoroalkane intermediates (resulting from protonation of the perfluoroalkyl carbanion leaving group) do not accumulate in solution due to their much greater reactivity with OH— than the parent PFSAs.

It is also notable that the finding of stoichiometric quantities of F⁻ and release of SO₄²⁻ from PFBS with t-ZrO₂ contrasts with work described above showing that hydrothermal catalytic PFBS degradation over a carbon supported ruthenium (Ru/C) catalyst, where only partial defluorination and no release of SO₄²⁻ were observed. With Ru/C, degradation is ascribed a mechanism initiated by C—C bond cleavage mechanism followed by chemisorption of resulting C-centered PFSA radical species to the carbon support material. It follows that an alternative mechanism is responsible for the observed hydrothermal PFBS degradation over ZrO₂.

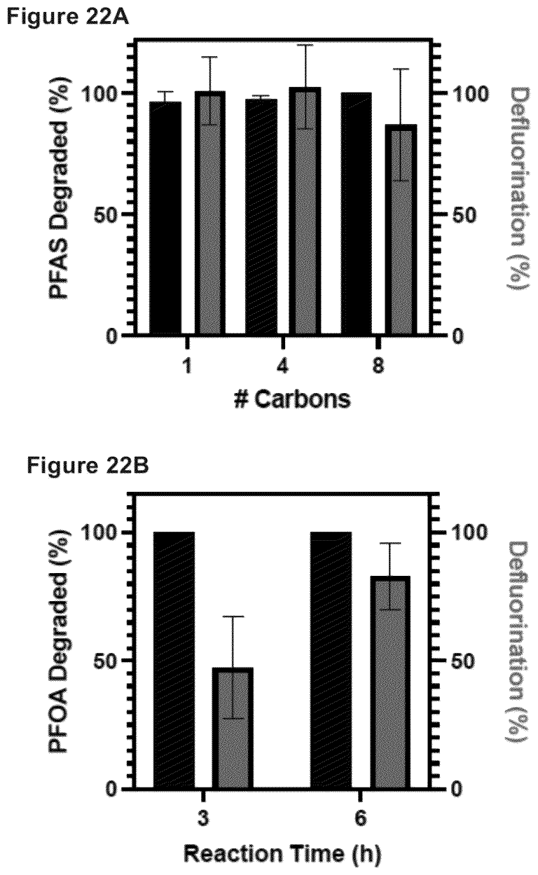

Experiments show that the catalytic reactivity t-ZrO₂ extends to other PFSAs (FIG. 22A) and PFOA, a perfluoroalkyl carboxylic acid (FIG. 22A). Like PFBS, the C4 PFSA, >98% degradation and stoichiometric release of F⁻ is observed for the C1 trifluoromethane sulfonic acid (TFMS) and the C8 perfluorooctane sulfonate (PFOS) after 3 h of reaction. The observed mineralization of TFMS is notable this structure was found to be unreactive with the heterogeneous Ru/C catalyst, which was attributed to the C1 structure lacking a C—C bond for the Ru catalyst to initiate reaction with. At the same time, TFMS is degraded by homogeneous hydrothermal alkaline treatment, where the proposed reaction mechanism is initiated by nucleophilic attack of OH— at the sulfonate headgroup.

FIG. 22B shows the extent of PFOA degradation and defluorination observed after reaction with t-ZrO₂ for 3 h and 6 h. PFOA is completely degraded at both reaction times, but the extent of fluoride release increases from 47% after 3 h to 82% after 6 h. Complete disappearance of the parent PFOA structure is to be expected because PFCAs undergo non-catalytic thermal decarboxylation at much lower temperatures than those used for the catalytic reactions studied here (350° C.). For example, past work shows that PFOA degrades within 30 min in hydrothermal water at temperatures as low as 200° C. Austin and co-workers recently showed that hydrothermal decarboxylation of trifluoroacetic acid (TFA; Hydrothermal Destruction and Defluorination of Trifluoroacetic Acid (TFA). Environmental Science and Technology. 58, 8076-8085, doi.org/10.1021/acs.est.3c09404), the C1 homologue of PFOA produces stoichiometric quantities of fluoroform, a 1H-perfluoroalkane, which is highly stable in the absence of strong alkali but rapidly mineralizes to F⁻ and formate when alkali is present. Moreover, catalyst-free control reactions show that PFOA degrades but no F⁻ is detected following 3 h of reaction. It follows that t-ZrO₂ is also able to promote mineralization of the presumed 1H-perfluoroheptane product resulting from non-catalytic decarboxylation of PFOA (this product is not amenable to LC-MS analysis methods used in this report). In addition, the lag between PFOA degradation and more complete defluorination is consistent with formation of this 1H-perfluoroalkane intermediate before reaction temperature is raised to conditions where further catalytic reaction to form F⁻ occurs. Since electrostatics may contribute to surface attraction of the solutes, loss of the anionic headgroup prior to the activation temperature would explain the depressed reaction rate. Additional experiments initiated with 1H perfluoroheptane are needed to confirm reactivity of this presumed intermediate with t-ZrO₂. Significance of Basic Surface Sites and a Catalytic Reaction Mechanism Derivation.

The significant difference in PFBS catalytic destruction activity observed for t-ZrO₂ versus m-ZrO₂ (FIG. 17A) is notable, and similar differences between these phases have been reported for other catalytic applications, including hydrocarbon alkylation, transesterification and isomerization. The activity difference between the two phases is frequently attributed to surface area and relative surface energy differences. However, differences in specific surface area of the two ZrO₂ phases cannot account for the marked difference in reactivity with PFBS observed here since specific surface area of the t-ZrO₂ phase (10 m² g⁻¹) is only double that of m-ZrO₂ (5 m² g⁻¹). Furthermore, we ran an experiment where the mass loading of m-ZrO₂ was doubled to match total surface area of t-ZrO₂ exposed to the reaction solution and still did not observe measurable fluoride ion release following reaction. It follows that other characteristics of the synthesized t-ZrO₂ are responsible for hydrothermal reactivity with PFBS.

ZrO₂ phases have documented acid-base catalyzed reactivity, and the documented homogeneous hydrothermal reactivity of PFSAs with OH— via a hydrolytic reaction mechanism is suggestive of t-ZrO₂ acting as a heterogeneous base catalyst in reactions with PFBS. Thus, an examination of acid-base site characteristics of the materials may be noteworthy. The greater coordination of Zr in t-ZrO₂ (Zr_{8C}) as compared to m-ZrO₂ (Zr_{7C}) can result in a higher surface energy which may be responsible for the observed reactivity of the former. Density functional theory (DFT) calculations conducted by Piskorz et al., Periodic DFT and Atomistic Thermodynamic Modeling of the Surface Hydration Equilibria and Morphology of Monoclinic ZrO₂ Nanocrystals. J. Phys. Chem. C 2011, 115 (49), 24274-24286; doi.org/10.1021/jp2086335, indicated that (111) planes on t-ZrO₂ contain a relatively high surface energy. Interestingly, XRD results shown in FIG. 17A reveal a relatively large presence of this facet in the t-ZrO₂ synthesized for this study. This may also explain the higher density of basic surface sites measured for this phase with CO₂ TPD (FIG. 17B). The tetragonal phase active sites have been reported to be more basic in nature than those on the surface of the monoclinic facets. Greater presence of basic sites on t-ZrO₂ compared to m-ZrO₂ is also supported by the higher pH of aqueous suspension of the former (˜pH 10.5) in comparison to the latter (˜pH 4.6) when the materials are equilibrated in deionized water. The importance of ZrO₂ surface site basicity in catalytic reactions with PFBS is further supported by a lack of reaction observed in tests with a sulfonated t-ZrO₂, since these materials have been shown to have higher activity for acid-mediated reactions, rather than base-mediate reactions, including ketonization, dehydration and alkylation.

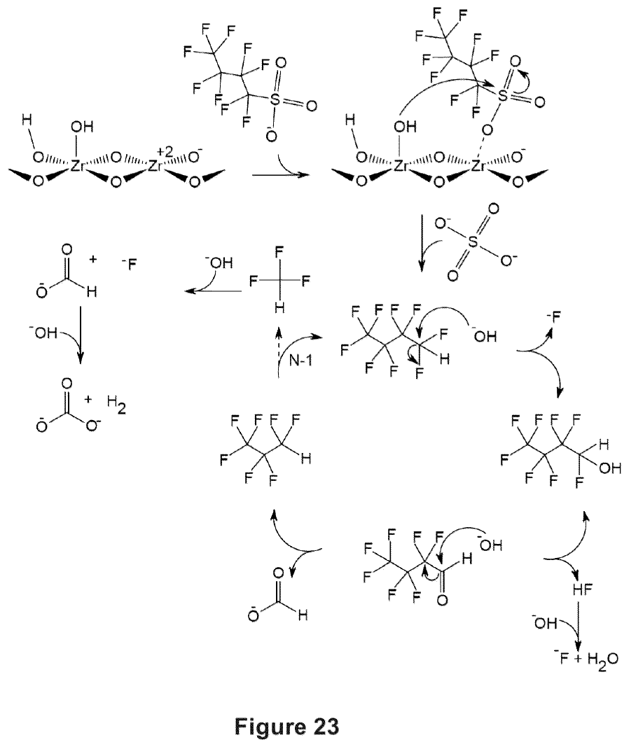

A heterogeneous base-catalyzed reaction mechanism is also consistent with the observation of complete release of F⁻ and SO₄²⁻ observed from PFBS for t-ZrO₂. These observations, as well as the lack of fluoro-organic intermediates being detected, are comparable to results observed during homogeneous reactions with OH—, but differ appreciably from results reported for heterogeneous catalytic reactions over Ru/C, where only partial defluorination and no release of SO₄²⁻ are observed, and H-substituted shorter chain PFSAs are detected in reaction solutions. Thus, whereas Ru/C is proposed to catalyze homolytic C—C bond cleavage within the fluoroalkyl chain, t-ZrO₂ active surface sites are proposed to either donate OH or coordinate PFSAs in a manner that promotes greater reactivity with solution phase nucleophiles. The presence of OH— facilitates hydrolytic cleavage of the sulfonate head group releasing a fluoroalkyl carbanion leaving group that is unstable and protonates to form a 1H-perfluoroalkane (FIG. 23). Then, analogous to the homogeneous hydrothermal alkali treatment mechanism, this structure can undergo repeated nucleophilic substitution reactions leading to F⁻ release and cyclic chain shortening. Final C1 products are broken down into carbonate and hydrogen through a formate as an intermediate.

The term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 6%, 5%, 4%, 3%, 2%, 1%, 0.5%, or 0.05% of a given value or range. Whenever the term “about” or “approximately” precedes the first numerical value in a series of two or more numerical values, it is understood that the term “about” or “approximately” applies to each one of the numerical values in that series.

The term “effective amount” refers to an amount of a compound, molecule, catalyst, composition, etc. of the present disclosure sufficient to provide for at least partial destruction of one or more PFAS compounds. Further, an effective amount with respect to a compound, molecule, catalyst, etc. of the present disclosure means that amount of compound alone, or in combination with one or more other compounds, that provides for remediation of a PFAS contaminated composition.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

All references disclosed herein, whether patent or non-patent, are hereby incorporated by reference as if each was included at its citation, in its entirety. In case of conflict between reference and specification, the present specification, including definitions, will control.

Although the present disclosure has been described with a certain degree of particularity, it is understood the disclosure has been made by way of example, and changes in detail or structure may be made without departing from the spirit of the disclosure as defined in the appended claims.

1. A method for degrading a per- or polyfluoroalkyl substance (PFAS), the method comprising:
heating a heterogeneous catalyst and/or a solution comprising the PFAS to a reaction temperature;
combining the heterogeneous catalyst and solution to create a catalyzed composition; and
maintaining the catalyzed composition at or near the reaction temperature for a duration sufficient to degrade the PFAS.

2. The method of claim 1, wherein the solution comprises a base amendment.

3. (canceled)

4. The method of claim 1, wherein the heterogeneous catalyst comprises a noble or transition metal selected from one or more of nickel, copper, cobalt, manganese, ruthenium, palladium, platinum, rhodium, or iridium.

5. (canceled)

6. The method of claim 1, wherein the heterogeneous catalyst comprises one or more of ruthenium on carbon (Ru/C), palladium on carbon (Pd/C), iridium on carbon (Ir/C), rhodium on carbon (Rh/C), platinum on carbon (Pt/C), nickel or nickel copper on zirconium dioxide, or titanium dioxide.

7. (canceled)

8. The method of claim 4, wherein the heterogeneous catalyst comprises monoclinic ZrO₂ (m-ZrO₂), tetragonal ZrO₂, t-ZrO₂ or combinations thereof.

9. (canceled)

10. The method of claim 8, wherein degradation of the PFAS results in liberating fluoride.

11. (canceled)

12. The method of claim 10, wherein the heterogeneous catalyst, the solution, or both are heated to the reaction temperature of between 150° C. and 374° C.

13. The method of claim 12, wherein the combining step includes flowing the solution through a bed of heterogeneous catalyst.

14. A system for degrading a per- or polyfluoroalkyl substance (PFAS) from a solution, the system comprising:
a reactor for containing the solution and a heterogeneous catalyst; and
a heater for heating one or more of the solution, the heterogeneous catalyst, and the reactor, wherein the reactor is configured to maintain a reaction temperature;
an in-flow conduit for transporting the solution to the reactor; and
an out-flow conduit for transporting a liquid from the reactor.

15. The system of claim 14 wherein, wherein the reactor is configured to contain a bed of heterogeneous catalyst, and the in-flow conduit is in fluid communication with a first side of the reactor and the out-flow conduit is in fluid communication with a second, opposite side of the reactor, wherein the solution comprises PFAS at a first concentration, and the liquid flowing from the reactor through the out-flow conduit comprises PFAS at a second concentration lower than the first concentration.

16. The system of claim 15 wherein, wherein the heterogeneous catalyst comprises a noble or transition metal on a support.

17. The system of claim 15, wherein the heterogeneous catalyst comprises a noble or transition metal selected from one or more of nickel, copper, cobalt, manganese, ruthenium, palladium, platinum, rhodium, or iridium.

18. (canceled)

19. The system of claim 15, wherein the heterogeneous catalyst comprises one or more of ruthenium on carbon (Ru/C), palladium on carbon (Pd/C), iridium on carbon (Ir/C), rhodium on carbon (Rh/C), platinum on carbon (Pt/C), nickel or nickel copper on zirconium dioxide, or titanium dioxide.

20. (canceled)

21. The system of claim 17, wherein the heterogeneous catalyst comprises monoclinic ZrO₂ (m-ZrO₂), tetragonal ZrO₂, t-ZrO₂, or combinations thereof.

22. (canceled)

23. The system of claim 17, wherein the system further comprises:
a base amendment, wherein the base amendment assists the heterogeneous catalyst in degrading the PFAS.

24. The system of claim 17, wherein fuel products are produced by the degrading of the PFAS or from one or more other organic compounds in the solution or by gasification of one or more organic compounds.

25. The system of claim 15, wherein the system is run in continuous or batch mode.

26. A composition of per- or polyfluoroalkyl substance (PFAS) degrading catalyst, the composition comprising:
water
the per- or polyfluoroalkyl substance; and
a heterogeneous catalyst comprising one or more of ruthenium on carbon (Ru/C), palladium on carbon (Pd/C), iridium on carbon (Ir/C), rhodium on carbon (Rh/C), platinum on carbon (Pt/C), nickel or nickel copper on zirconium dioxide, or titanium dioxide;
wherein, the composition is at a temperature between 150° C. and 374° C.

27-31. (canceled)

32. The composition of claim 26, wherein the heterogeneous catalyst comprises monoclinic ZrO₂ (m-ZrO₂), tetragonal ZrO₂, t-ZrO₂, or combinations thereof.

33. (canceled)

34. The composition of claim 32, wherein the composition further comprises:
a base amendment, wherein the base amendment is selected from one or more of sodium hydroxide or sodium carbonate and increases the amount of the PFAS degraded by the heated composition.

35. (canceled)
